(19) United States
(12) Patent Application Publication
(10) Pub. No.: US 2026/0122511 A1
(43) Pub. Date: Apr. 30, 2026

(54) METHODS FOR WIRELESS BASE STATION GROUPING & CLUSTERING FOR NETWORK DEPLOYMENT AND ENHANCED USER EXPERIENCE

(71) Applicant: Charter Communications Operating, LLC, St. Louis, MO (US)

(72) Inventors: Pareshkumar Panchal, Highlands Ranch, CO (US); Noah Y. Polizzotto, Castle Rock, CO (US)

(21) Appl. No.: 18/932,962

(22) Filed: Oct. 31, 2024

(51) Int. Cl. H04W 16/18; H04W 64/00

(52) U.S. Cl. CPC H04W 16/18; H04W 64/003

(57) ABSTRACT

A base station management resource as discussed herein produces multiple base station cluster installation plans. Each of the multiple base station cluster installation plans indicates a corresponding set of wireless base stations to provide wireless services in a network environment. The base station management resource then determines a respective wireless service performance associated with each of the multiple base station cluster installation plans. Based on the determined respective wireless service performance associated with each of the multiple base station cluster installation plans, the base station management resource or other suitable entity initiates installation of a selected base station cluster installation plan of the multiple base station cluster installation plans in the network environment.

### BACKGROUND

Conventional wireless technology has been used for many years to connect wireless devices such as phones, laptops, etc., to a landline network and other wireless networks. Today, such wireless networks support many different types of connection services such as voice communications, cell communications, high-speed data services, Wi-Fi™ connectivity, and so on.

Cellular networks typically include a land area that has been divided into so-called cellular regions. A single base station typically resides in each cell. Often, the base station is connected to a landline network and supports communication with one or more wireless subscribers operating in a region covered by the cell. Accordingly, a wireless subscriber operating a cell phone in the cell is able to communicate with or have access to a landline network and remote network via a wireless link between the subscriber and a base station.

Conventional long-range cellular networks sometimes do not have the ability to provide connectivity to users at every location in a geographical region. One reason for this shortcoming is the high cost associated with designing and subsequently implementing a long-range cell tower for every portion of a geographical region. In many instances, a cell tower providing long-range coverage requires a long-term financial commitment. In certain instances, because costs are so high, a service provider may not even install a cell tower because it is not a good investment.

In certain cases, a respective wireless network service provider installs many short range wireless base stations to provide respective subscribers access to a respective remote network. Many factors can be used to determine where to install wireless base stations.

### BRIEF DESCRIPTION OF EXAMPLES

This disclosure includes the observation that, in a wireless communication network, decision making for deployment of wireless services in a respective one or more geographical regions can be challenging. Normally, conventional wireless base station deployment decisions are driven by multiple factors according to business strategies and parameters such as cost, time, competition, etc. In most cases, once a wireless base station implementation decision has been made for a geographical region, a team of installation experts is deployed to install the wireless base stations according to a respective installation plan. If deployment sites are not well selected, implementation of a new wireless network may provide only poor performance, resulting in lower revenue generation due to multiple factors such as less traffic per wireless base station site, higher interference at a wireless base station site, lower spectral efficiency at a wireless base station site, larger cost of deployment, slower time to market, etc. Also, in certain instances, predicted traffic changes may not be aligned at the time of a deployment decision. These undesirable impacts may continue for an entire deployment phase (3-5 years).

To provide better use of wireless resources in the network environment, techniques as discussed herein provide improved implementation of selecting and installing clusters of base stations to provide more efficient wireless services to respective wireless communication devices.

More specifically, an installation management resource as discussed herein produces multiple base station cluster installation plans, where each of the multiple base station cluster installation plans indicates a corresponding set of wireless base stations to provide wireless services in a network environment. The installation manager resource further determines a respective wireless service performance associated with each of the multiple base station cluster installation plans. Based on the determined respective wireless service performance associated with each of the multiple base station cluster installation plans, the installation manager resource or other suitable entity initiates (causes) installation of base stations associated with a selected base station cluster installation plan of the multiple base station cluster installation plans.

As further discussed herein, the multiple base station cluster installation plans include a first group of base station cluster installation plans, a second group of base station cluster installation plans, and a third group of base station cluster installation plans.

In one example, the first group of base station cluster installation plans is produced based on first wireless service attributes or metrics of the network environment; the second group of base station cluster installation plans is produced based on second attributes or metrics of the network environment; and the third group of base station cluster installation plans is produced based on third attributes or metrics of the network environment.

In yet further examples, wherein each of the multiple base station cluster installation plans specifies locations of installing the corresponding set of wireless base stations in the network environment. The installation management resource as discussed herein is further operative to: receive selection criteria indicating at least one selected attribute of interest associated with the multiple base station cluster installation plans; and choose a base station cluster installation plan amongst the multiple base station cluster installation plans based on the at least one selected attribute of interest.

Still further examples as discussed herein include, the installation management resource: receiving attributes associated with different locations in the network environment, the received attributes including: i) wireless service demand information (so-called usage information) indicating a projected level of demand for wireless services at each respective location within the network environment, ii) wireless signal conveyance information (wireless signal strength information) indicating an ability to communicate wireless signals at each respective location within the network environment, and iii) wireless signal interference information indicating a projected level of wireless interference at each respective location within the network environment.

The multiple base station cluster installation plans can be configured to include a first base station cluster installation plan, a second base station cluster installation plan, and a third base station cluster installation plan. Each of the multiple base station cluster installation plans can be generated based on a different set of received wireless network parameters associated with different locations in the network environment.

Yet further, the installation management resource can be configured to: produce the first base station cluster installation plan based on a combination of the wireless service demand information, the wireless signal strength information, and the wireless signal interference information; produce the second base station cluster installation plan based on a combination of the wireless service demand information and the wireless signal strength information; and produce the third base station cluster installation plan based on a combination of the wireless demand information and the wireless signal interference information.

In further examples, subsequent to generating the multiple base station cluster installation plans, the installation management resource receives cluster selection criteria indicating a specified attribute of interest. The installation manager resource or other suitable entity then chooses a base station cluster installation plan amongst the multiple base station cluster installation plans based on the specified attribute interest.

Still further, each of the multiple base station cluster installation plans can be iteratively generated based on respective cluster build criteria indicating at least one wireless network installation parameter. The iterative operations eventual convergence of a respective installation plan into a final base station cluster installation plan optimized with respect to one or more initial network parameters for the given plan.

These and other examples are further discussed herein.

Note that the examples as discussed herein are useful over conventional techniques. For example, implementation of a communication management resource and corresponding operations as discussed herein provide more efficient deployment of wireless base stations in the network environment to provide desired wireless services.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable hardware storage on which software instructions are encoded for subsequent execution. The computer-readable storage hardware for storing instructions may be configured as a non-transitory computer-readable storage medium. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer-readable storage hardware such as a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example herein includes computer-readable storage hardware and/or system having instructions stored thereon. The instructions, when executed by the computer processor hardware, cause the computer processor hardware (such as one or more co-located or disparately processor devices or hardware) to: produce multiple base station cluster installation plans, each of the multiple base station cluster installation plans indicating a corresponding set of wireless base stations to provide wireless services in a network environment; determine a respective wireless service performance associated with each of the multiple base station cluster installation plans; and based on the determined respective wireless service performance associated with each of the multiple base station cluster installation plans, initiate installation of base stations associated with a selected base station cluster installation plan of the multiple base station cluster installation plans.

Note that the ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved efficiency of installing respective wireless base stations in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating execution of a base station installation management resource and corresponding installation management system as discussed herein.

FIG. 2 is an example diagram illustrating operation of a base station installation algorithm as discussed herein.

FIG. 3 is an example diagram illustrating implementation of a fitness calculation associated with the base station installation algorithm as discussed herein.

FIG. 4 is an example diagram illustrating a graphical user interface indicating a first set of selected parameters (cluster build criteria) for producing first base station installation plan information as discussed herein.

FIG. 5 is an example diagram illustrating expected wireless coverages provided by a first set of proposed wireless base stations as indicated by a first base station installation plan information as discussed herein.

FIG. 6 is an example diagram illustrating a fitness convergence calculation associated with the first base station installation plan information as discussed herein.

FIG. 7 is an example diagram illustrating a graphical user interface indicating a second set of selected parameters (cluster build criteria) for producing second base station installation plan information as discussed herein.

FIG. 8 is an example diagram illustrating expected wireless coverages provided by a second set of proposed wireless base stations as indicated by the second base station installation plan information as discussed herein.

FIG. 9 is an example diagram illustrating a fitness convergence calculation associated with the second base station installation plan information as discussed herein.

FIG. 10 is an example diagram illustrating a graphical user interface indicating a third set of selected parameters (cluster build criteria) for producing the third base station installation plan information as discussed herein.

FIG. 11 is an example diagram illustrating expected wireless coverages provided by a third set of proposed wireless base stations as indicated by the third base station installation plan information as discussed herein.

FIG. 12 is an example diagram illustrating fitness convergence associated with the third base station installation plan information as discussed herein.

FIG. 13 is an example diagram illustrating generation of performance metrics associated with the multiple base station installation plans and selection of a base station installation plan amongst the multiple base station installation plans as discussed herein.

FIG. 14 is an example diagram illustrating first performance information associated with the multiple base station installation plans as discussed herein.

FIG. 15 is an example diagram illustrating second performance information associated with the multiple base station installation plans as discussed herein.

FIG. 16 is an example diagram illustrating third performance information associated with the multiple base station installation plans as discussed herein.

FIG. 17 is an example diagram illustrating fourth performance information associated with the multiple base station installation plans as discussed herein.

FIG. 18 is an example diagram illustrating example computer hardware and software operable to execute operations as discussed herein.

FIG. 19 is an example diagram illustrating a method as discussed herein.

The foregoing and other objects, features, and advantages of the invention (as described in the following examples) will be apparent from the following more particular description of preferred implementations herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

In one example, a base station management resource as discussed herein produces multiple base station cluster installation plans. Each of the base station cluster installation plans specifies multiple candidate base stations for installation in a respective geographical region to provide corresponding wireless services. The base station management resource determines a respective wireless service performance associated with each of the multiple base station cluster installation plans. Based on the determined respective wireless service performance associated with each of the multiple base station cluster installation plans, as well as based on installation selection criteria, the base station management resource or other suitable entity initiates installation of a selected one or more base station cluster installation plans of the multiple base station cluster installation plans in the network environment.

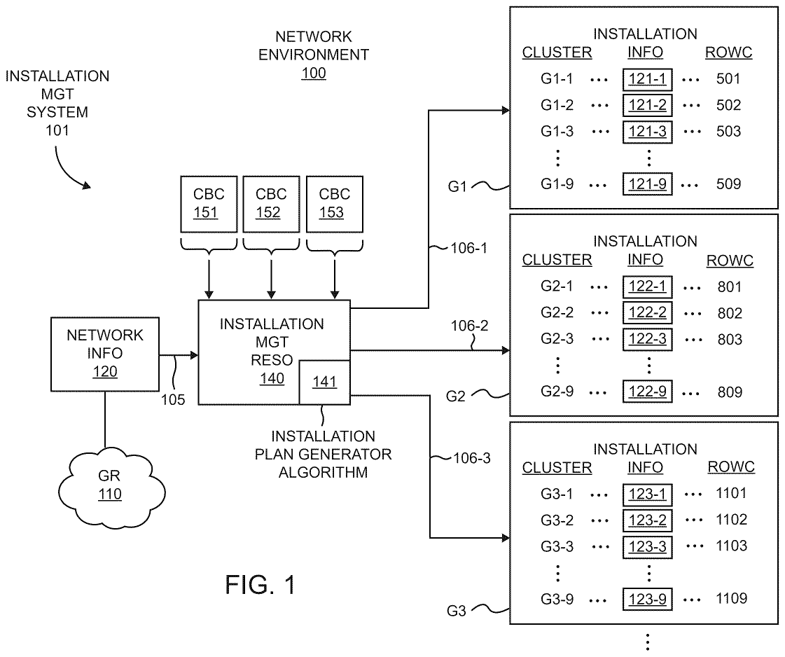

Now, more specifically, with reference to the drawings, FIG. 1 is an example diagram illustrating execution of a base station installation management resource as discussed herein.

It is noted that a Hybrid Mobile Network (such as including the first wireless network and a second wireless network) is a flexible wireless network solution that provides customers the flexibility to switch back and forth between two wireless networks (primary and secondary) based on the radio frequency (RF) environment the user is in while using their mobile communication device.

One goal of an HMNO (Hybrid Mobile Network Operations) is to deploy a “primary” wireless network (such as a small cell network) where corresponding users (a.k. a., subscribers of the primary wireless network) are connected for a majority of the time they use their devices to connect to a respective remote network. The communication device operated by a respective subscriber can be configured to intelligently switch between the primary wireless network and the secondary wireless network when the device is no longer within the coverage footprint of the primary wireless network. This may occur when the user and corresponding device are travelling to and from different locations in a network environment.

It is desirable that the HMNO deploys the primary wireless network in a way that will result in as much offload (to the primary wireless network) as possible on the fewest number of sites, which requires clustering these small cells together to function in a way such as a single wireless entity to monitor the performance of the network at a higher-level view.

As shown in FIG. 1, the network environment 100 can be configured to include the geographical region 110 as well as a base station installation management resource 140. The base station installation management resource 140 can be configured to include a respective installation plan algorithm 141, which is used as a basis to propose different clusters of base stations to install in the geographical region 110.

The base station installation management resource 140 can be configured to receive input 105 such as: base station coverage files, base station locations and names, traffic file, interference and coverage results per base station, etc. The base station installation management resource 140 can be configured to produce output 106 such as: base station grouping as per the received input (number of base stations per cluster, traffic per cluster, weight of traffic, coverage and interference etc.).

Note that each of the resources as discussed herein can be configured as hardware, software, or a combination of hardware and software. More specifically, the base station installation management resource 140 can be implemented as base station installation management hardware, base station installation management software, or a combination of base station installation management hardware and base station installation management software; the installation plan algorithm 141 can be implemented as installation plan hardware, installation plan software, or a combination of installation plan hardware and installation plan software; and so on.

More specifically, the installation management system 101 is shown in FIG. 1 can be configured to include the base station installation management resource 140. As shown, the base station installation management resource 140 can be configured to receive input 105 such as network information 120.

As previously discussed, the input 105 and corresponding network information 120 may include base station coverage files, base station locations and names, traffic file, interference and coverage results per base station, etc. Yet further, note that the network information 120 can be configured to include information regarding locations of obstacles such as trees, mountains, buildings, etc., in the geographical region 110. The network information 120 can be configured to include infrastructure information indicating locations of different available resources such as cables or other resources in which to connect a proposed wireless base station, powers lines available to supply respective wireless base stations, etc. Additionally, the network information 120 can be configured to include mobile communication device data/traffic usage information (such as indicating so-called tonnage) indicating a respective density of subscriber users and corresponding expected demand of mobile communication devices using a newly installed wireless network and corresponding wireless base stations in the geographical region 110 at different locations. The network information 120 can be configured to include any suitable information (such as path loss information) enabling the installation management resource 140 to determine possible network coverage such as based on RSRP (Reference Signal Received Power, such as indicating a respective wireless signal strength expected in each of the different locations of the geographical region 110). The network information 120 further can be configured to include any suitable information enabling the installation management resource 140 to determine expected wireless interference at each location in the geographical region 110 such as expected SINR (Signal-to-interference-plus-noise ratio) associated with each of the different locations in the geographical region 110, where the SINR indicates expected wireless signal quality.

Small cell site locations offer unique performance characteristics when deployed in typical HMNO strategies which is usually centered around deploying small cells only in areas of high user density and usage. This however can come at the cost of coverage contiguity and signal to noise interference that results from many base stations in the same area radiating at the same time on the same radio frequency (RF) spectrum. To balance the needs of deploying the network in a profitable manner, account for user experience by limiting high interference when possible, while also ensuring there is enough coverage contiguity during different phases of deployment requires a precise strategy of clustering these small cells together during their deployment and operation is desirable in order to maximize their effectiveness during offload of user traffic while operating seamlessly in the background while the user uses their device.

There are countless different ways to cluster things together from a mathematical operations perspective which makes the iterative process of finding the best way to cluster small cells together difficult as there is a lot of trial and error involved to identify the best method possible. However, there are three key performance indicators (KPIs) that can be used to judge the effectiveness of a small cell cluster of wireless base stations, where the key performance indicators can be used as discrete weighting factors of different parameters such as expected wireless base station usage (tonnage) at each of the different locations in the geographical region 110, expected network availability or signal strength (RSRP or other parameter) and each of the different locations in the geographical region 110, expected wireless interference (SINR or other parameter) at each of the different locations in the geographical region 110, etc.

As further discussed herein, each instance of the cluster build criteria 151, 152, 153, received by the installation management resource 140 may include different sets of selected parameters to generate candidate wireless base station installation plans such as indicated by the cluster base station plans G1, G2, G3, etc., each cluster base station plan including multiple clusters of wireless base stations.

### Such Parameters May Include

1. Tonnage Offload (mobile communication device usage in different locations of the geographical region 110): it is noted that the network information 120 can be configured to include a data traffic model that indicates with a reasonable degree of accuracy where their customers and corresponding communication devices use or will use wireless communication links such as based around the density of events captured through their core network connection manager while their customer is connected to the secondary network that is run by the tier 1 mobile network operator (MNO) that has been responsible for offload of user traffic prior to deployment of the primary network. With this level of spatial granularity indicating expected usage of wireless services by the different communication devices operated in the geographical region 110, planning and strategy can be focused on how much tonnage (data offload) a site will offload using this dataset as a weighting factor. In summary, the more traffic the service provider implementing the new one or more clusters of base stations is able to predict a corresponding site in the geographical region 110 will offload to the primary wireless network once installed, the service provider may be more confident to deploy one or more clusters of the wireless base stations as indicated by the different installation plans.
2. Signal to Noise Ratio (SINR)/Interference: One of the single biggest contributing factors to the performance of user equipment (UE) on a wireless network is the level of SINR is relation to the signal strength the UE is receiving from the base station. Thankfully, this key performance metric can be simulated in wireless design software. When calculating predictions of coverage characteristics in these wireless network design software platforms, SINR can also be calculated with a reasonable degree of accuracy. This allows the HMNO, prior to deploying their wireless network to assess the performance of small cell sites before deploying them in the field. This allows the HMNO to iterate on ways to cluster sites together in a way that will improve the SINR of the network in different regions of the market to reduce the amount of interference experienced by the user while they are connected to the primary network. Median value of interference can drive the ranking of cluster with reference to other cluster. It will also be helpful while selecting or grouping sites. For example: an algo can be run with multiple iterations to review the best interference environment to choose the clustering.
3. Coverage: as per the base station capability in terms of transmission, there will be coverage differences in terms of deployment geography and base station parameters such as height, azimuth, types and more. average coverage signal strength depends on base station density deployment. Its important to have better coverage with less interference. Each base station will have average coverage strength based on location and other related parameters.

With these KPIs (a.k.a., performance metrics such as parameters including one or more of tonnage, RSRP, SINR, etc.), The installation plan generator algorithm 141 can be configured to implement weighted factors to produce each of the cluster plans (G1, G2, G3, etc.) each cluster plan including multiple proposed clusters of wireless base stations randomly generated from a respective one or more seed value. Through a mutation factor applied to each generation of iterative cluster schemas, naturally, each successive cluster schema produced by the installation plan generator algorithm 141 will converge via the iterations on an optimal clustering schema to produce the respective cluster plans G1, G2, G3, etc.

As further discussed later in this disclosure, each of the different cluster plans G1, G2, G3, etc., can be analyzed to generate respective performance metrics that are later used as a basis in which to apply one or more threshold criteria (cluster selection criteria) to determine which of the proposed wireless base station cluster plans (each including multiple wireless base stations) is going to be implemented in the geographical region 110. In certain instances, For the most optimal cluster schema possible, the cluster plans must meet a minimum threshold for one or more performance metrics (a.k. a., KPIs or key performance indicators).

### Using an Algorithm 141 with Following Criterion

There are a few other parameters besides the KPIs of tonnage offload, RSRP, SNIR, etc., to consider when building clusters via the installation plan generator algorithm 141. Though not entirely as important as the tonnage and SINR KPIs, the following characteristics may be considered as well when performing the iterative operations to produce the most efficient and optimal clustering schema. To produce the most effective clusters possible, the following secondary objectives must be considered as well and could be market specific:
1. Compactness: Because of the small footprint of small cells, the clusters formed by the algorithm must be as compact and contiguous as possible for the best performance. This means that sites with a lower inter-site distance to each other are considered more related to each other in their performance, which leads to a better RF environment when clustered together.
2. Number of Sites: For both deployment and operational reasons, the size of small cell clusters must be within a certain range. There is a slight amount of variation allowable in the amount of sites per cluster, but generally speaking, the deployment and operation of the network will be better suited if each cluster has around the same amount of sites.
3. Minimum Tonnage: Though it is possible to extrapolate what the minimum amount of offload would be required for an individual small cell to be profitable towards the business case of the HMNO, sometimes sites that cannot meet the financial incentives of the business case must be deployed in order to maintain things such as contiguity in the network. When paired with small cells that exceed the minimum expectations for net present value (NPV), the total tonnage offloaded by the cluster as a whole can still meet or exceed the business case. Though ethereal in nature, the presence of small cells nearby to each other allow for a better RF environment that will increase the chances the user will maintain a connection on the primary network, leading to a stronger overall performance of the network with the added coverage contiguity to link positive NPV sites together with negative NPV sites to maintain seamless coverage where it is desired.
4. Interference: When clustered together, small cells can operate on a different channel than surrounding sites in order to reduce the amount of interference the UE receives from nearby interference sources. With a minimum level of SINR in mind, compared to the global SINR produced by primary network, intelligent clustering schemas can be achieved by trying to optimize the local SINR in the RF environment the UE is present within in relation to the global SINR produced by the primary network and other interfering devices.
5. Coverage: average coverage or signal strength per cluster (grouping).

With all of these objectives in mind, the installation plan generator algorithm 141 can be configured to implement a weighting of these parameters when generating the respective cluster plans G1, G2, G3, etc. For example, the algorithm 141 can be configured to start from random points within a dataset it is building from a random seed. The algorithm 141 can be configured to continuously monitor the achievement of objectives set forth in the cluster building criteria (151, 152, 153, etc.) and cluster selection criteria inputted by respective personnel such as an engineer, technician, etc., as the algorithm 141 adds random nearby sites to the clusters it is building to produce the respective cluster plans for those set of selected parameters. Through constant iterative construction of clusters through genetic family trees based from a random seed and a mutation factor set by the technician, the algorithm 141 eventually converges on a respective schema (a.k. a., cluster plan of proposed installation of multiple clusters of multiple wireless base stations) that meets or exceeds the attribution thresholds set by the technician to produce a clustering schema that reaches the optimal performance characteristics from the two important KPIs (Key Performance Indicators) mentioned earlier. Note that convergence on the optimal schema by the algorithm 141 may be aided by allowing the algorithm 141 exploring a higher amount of child generations produced through the mutation of the schema through each iteration. However, the greater amount of child generations the algorithm 141 is allowed to explore when generating the final proposed installation plans, the more time and processing power is required in order to produce the most optimal schema possible.

### Example Use Cases

The following are real world applications of the installation management resource 140 and the installation plan generator algorithm 141 (such as tool/methodology) and how they differ from conventional techniques of generating cluster plans:
1. Macro anchored, small cell densification; the HMNO is experiencing capacity exhaust from its macro sites that radiate a lower frequency spectrum and needs small cells to provide capacity relief:
   a. Compactness: A centralized macro site is used as an anchoring point to cluster small cells around.
   b. SINR: (Local) SINR is used as a weighted factor to balance interference inside of the footprint of the macro site to boost the capacity of offload by small cells radiating a higher frequency spectrum.
   c. Number of Sites: Only sites contained fully or partially within the footprint of the macro are considered for a single cluster
   d. Minimum Tonnage: Each small cell must offload a minimum amount of tonnage to be considered viable for deployment given the capacity objective of the design.
2. Offload/Traffic Focused; the HMNO is purely focused on the volume of offload and is not as worried about coverage contiguity issues:
   a. Compactness: Sites must be contiguous with each other to increase the odds of the UE staying within the footprint of the primary network, this factor is given a higher weight.
   b. Number of Sites: The number of sites per cluster is less important in this schema, but a minimum number is required for viable deployment based on the impact of how fast the UE travels within the footprint of the small cells in order to keep the UE within the footprint long enough to offload traffic.
   c. Minimum Tonnage: The cluster as a whole must meet a minimum threshold of tonnage while also reaching the minimum amount of sites required to form a cluster.
   d. SINR: SINR is a lower weighted priority as long as the UE is within the footprint of the primary network. Since the UE is expected to switch to the secondary network more often in this scenario, SINR is not as relevant as long as it does not exceed a given minimum value.
   e. Morphology: Different values of the above metrics are given if the small cells are within a suburban or urban morphology. Note that switch component morphology dictates how the small cells radiate, on average, through different variations of clutter after the model tuning process has been completed using real world datasets such as Continuous Wave (CW) drive data. If a site is within an urban morphology, things such as their coverage footprint, SINR, etc. may differ compared to a site within a suburban or rural morphology and therefore must be considered when clustering sites together in an optimal manner.
3. Equal number of sites/coverage; The HMNO plans to deploy and operate clusters as homogenous areas of coverage:
   a. Compactness: To maintain a balance of sites per cluster, the compactness restriction is loosened to allow for greater flexibility in the selection of sites for each cluster to ensure an even distribution.
   b. Number of sites: The highest weight is given to balance the number of sites per cluster to ensure optimal distribution of sites across clusters.
   c. SINR: SINR is balanced as best as possible while trying to maintain an even amount of sites per cluster but is not a highly weighted factor.
   d. Minimum Tonnage: A minimum amount of tonnage is still required to justify the deployment of a cluster based on what the optimal number of sites per cluster is in the schema. A cluster is not deployed if the minimum tonnage is not met even if the target number of sites is met.

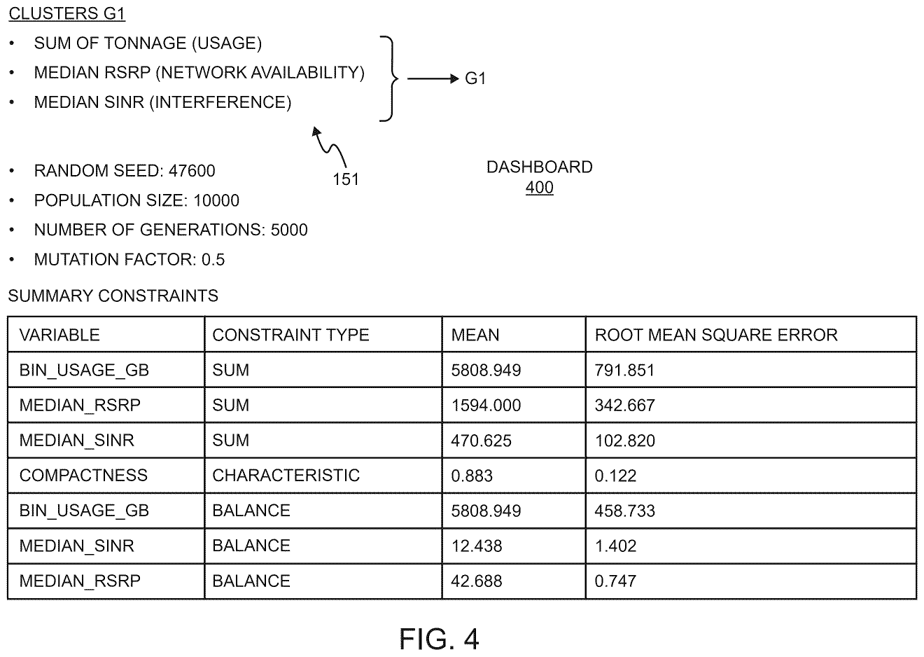

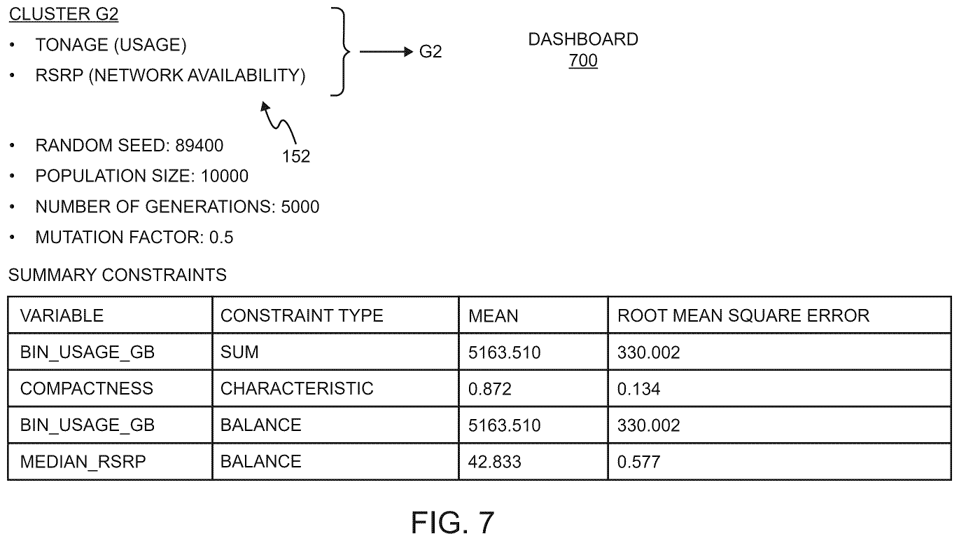

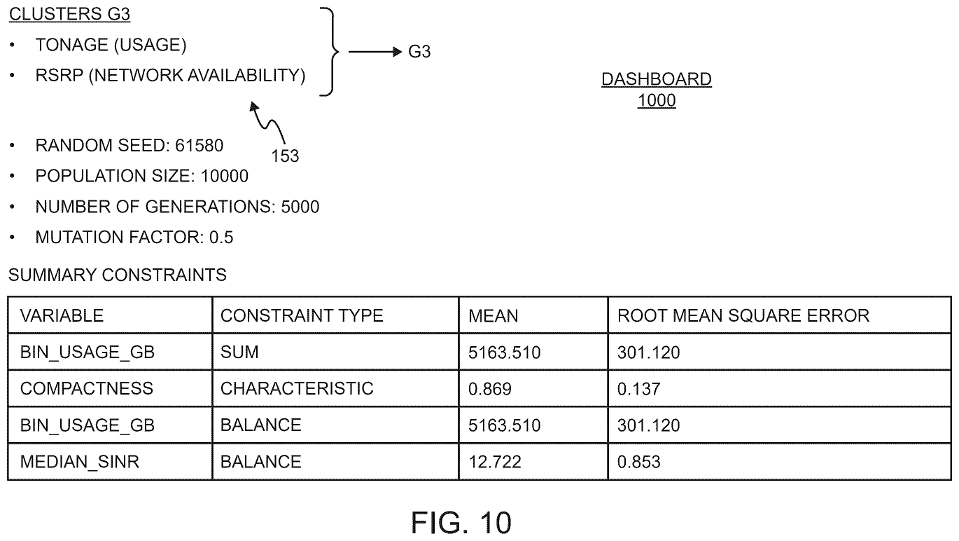

Below are three different ways to demonstrate base station grouping (clustering) and making deployment decisions.
1. As shown in FIGS. 4-6, the installation management resource 140 and corresponding installation plan generator algorithm 141 can be configured to generate the cluster installation plans G1 based on multiple parameters such as Tonnage sum, RSRP, and SINR.
2. As shown in FIG. 7-9, the installation management resource 140 and corresponding installation plan generator algorithm 141 can be configured to generate the cluster installation plans G2 based on multiple parameters such as Tonnage sum and RSRP.
3. As shown in FIG. 10-12, the installation management resource 140 and corresponding installation plan generator algorithm 141 can be configured to generate the cluster installation plans G3 based on multiple parameters such as Tonnage sum and SINR.

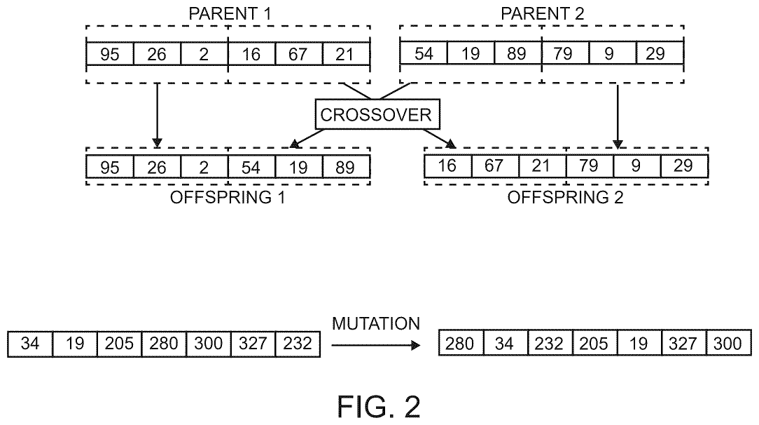

FIG. 2 is an example diagram illustrating operation of a base station installation algorithm as discussed herein.

In one example, a random seed (such as a base station) is derived by the installation plan algorithm 141 using any suitable method (such as ACM599, Mersenne Twister mt19937, Standard C Rand, etc.).

The seed is used to pick which units (base station sites) the corresponding clustering plan begins from.

Sites may be grouped (randomly) and a fitness score may be calculated by the installation plan algorithm 141 or other suitable entity based on how much they satisfy the cluster building criteria (such as cluster building criteria including one or more of Tonnage, SINR, RSRP, site counts, etc.).

Note that each site starts as a possible solution. The sites with the best fitness score may be used as starting points for the next generation of solutions.

Further, via the installation plan algorithm 141, multiple generations (offspring) of prior clusters may be crossed over with each other to continuously iterate on constructing clusters until the limit of generations are reached, using the total fitness score to converge as close to 0 as possible, resulting in finalization of respective cluster plan information associated with each of the cluster plan G1 (such as including cluster of wireless base stations G1-1, cluster of wireless base stations G1-2, cluster of wireless base stations G1-3, . . . ), cluster plan G2 (such as including cluster of wireless base stations G2-1, cluster of wireless base stations G2-2, cluster of wireless base stations G2-3, . . . ), cluster plan G3 (such as cluster of wireless base stations G3-1, cluster of wireless base stations G3-2, cluster of wireless base stations G3-3, . . . ), etc.

To add randomness (read; variance) into the cluster building schema, a mutation factor and/or alien (non-offspring) populations (read; sites) can be introduced to help the fitness converge on solutions that would not otherwise be possible through typical genetic inheritance.

Note further that fitness convergence can be accelerated by crossing over offspring from previous generations.

Additionally, to increase diversity in the population of possible wireless base station installation plan solutions, aliens can be introduced to the population pool.

Lastly, as generations are created, random mutations can be introduced to subtly change (and hopefully assist) fitness convergence as more and more fit generations are produced.

Referring again to FIG. 1, further in this example, the installation management resource 140 can be configured to include the installation plan generator algorithm 141 to produce respective base station cluster plans G1, G2, G3, etc., based upon the combination of the network information 120 received as input 105 and corresponding input build criteria such as cluster build criteria 151, cluster build criteria 152, cluster build criteria 153, etc.

For example, the installation management resource 141 and corresponding installation plan generator algorithm 141 can be configured to use a combination of the network information 120 and the cluster build criteria 151 (such as specifying a first set of parameters such as tonnage, SINR, and RSRP) as a basis in which to generate base station cluster plan G1 (multiple installation plans) including: proposed installation information 121-1 (plan) indicating how to implement a first set of wireless base stations associated with the cluster of base stations G1-1 to provide first wireless coverage 501 in the geographical region 110; proposed installation information 121-2 indicating how to implement a second set of wireless base stations associated with the cluster of base stations G1-2 to provide second wireless coverage 502 in the geographical region 110; the proposed installation information 121-3 indicating how to implement a third set of wireless base stations associated with the cluster of base stations G1-3 to provide third wireless coverage 503 in the geographical region 110, and so on. As previously discussed, this is further illustrated in FIGS. 4-6.

The installation management resource 141 and corresponding installation plan generator algorithm 141 can be configured to use a combination of the network information 120 and the cluster build criteria 152 (such as specifying a second set of parameters tonnage and RSRP) as a basis in which to generate base station cluster plan G2 including: proposed installation information 122-1 indicating how to implement a first set of wireless base stations associated with the cluster of base stations G2-1 to provide first wireless coverage 801 in the geographical region 110; proposed installation information 122-2 indicating how to implement a set of wireless base stations associated with the cluster of base stations G2-2 to provide second wireless coverage 802 in the geographical region 110; the proposed installation information 122-3 indicating how to implement a third set of wireless base stations associated with the cluster of base stations G2-3 to provide third wireless coverage 803 in the geographical region 110, and so on. As previously discussed, details associated with the cluster installation plan G2 is further illustrated in FIGS. 7-9.

The installation management resource 141 and corresponding installation plan generator algorithm 141 can be configured to use a combination of the network information 120 and the cluster build criteria 153 (such as specifying a third set of parameters such as tonnage and SINR) as a basis in which to generate base station cluster plan G3 including: proposed installation information 123-1 indicating how to implement a first set of wireless base stations associated with the cluster of base stations G3-1 to provide first wireless coverage 1101 in the geographical region 110; proposed installation information 123-2 indicating how to implement a second set of wireless base stations associated with the cluster of base stations G3-2 to provide second wireless coverage 1102 in the geographical region 110; the proposed installation information 123-3 indicating how to implement a third set of wireless base stations associated with the cluster of base stations G3-3 to provide third wireless coverage 1103 in the geographical region 110, and so on. As previously discussed, this is further illustrated in FIGS. 10-12.

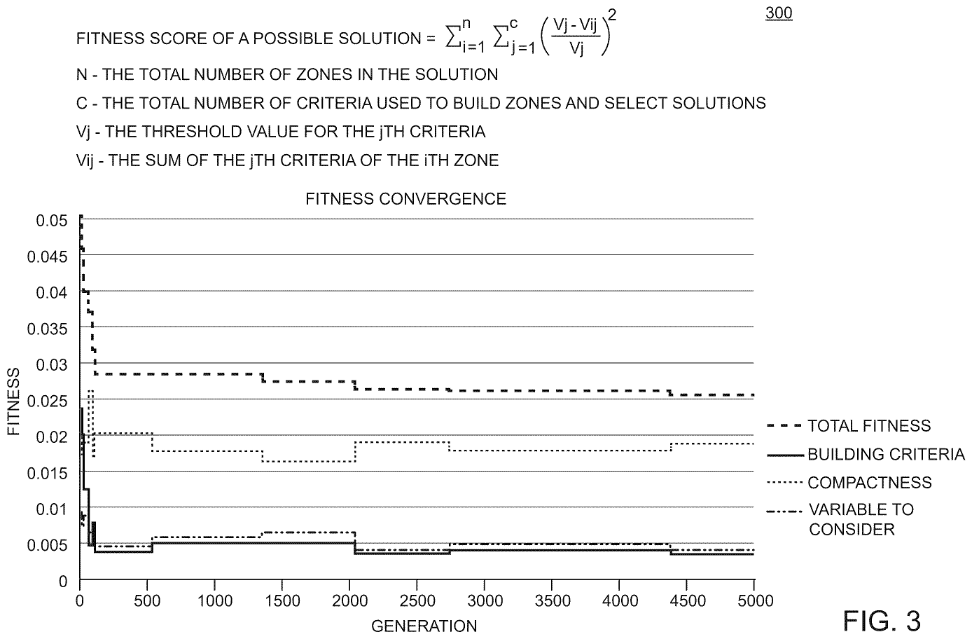

FIG. 3 is an example diagram illustrating implementation of a fitness calculation associated with the base station installation algorithm as discussed herein.

As shown in graph 300 of FIG. 3, as greater fitness scores are discovered via the installation plan algorithm 141, through prior generations, mutations, and introduction of aliens to the population of producing a respective base station installation plan, the clustering algorithm (i.e., installation plan algorithm 141) naturally converges as close to an ideal fitness score as possible (such as around 0) for each generated wireless base station cluster plan. Note that it may be unlikely that a perfect solution exists in certain datasets (a perfect fitness convergence of 0), but the likelihood of finding one increases with greater and greater number of generations (iterations) and mutations.

FIG. 4 is an example diagram illustrating a graphical user interface indicating a first set of selected parameters for producing first base station installation information as discussed herein.

In this example, the dashboard 400 (such as displayed on a respective display screen of the installation management resource 140) indicates the corresponding parameters associated with the cluster building criteria 151 for generation of the cluster plans G1. Additionally, the dashboard 400 indicates additional attributes associated with generation of the cluster plans G1.

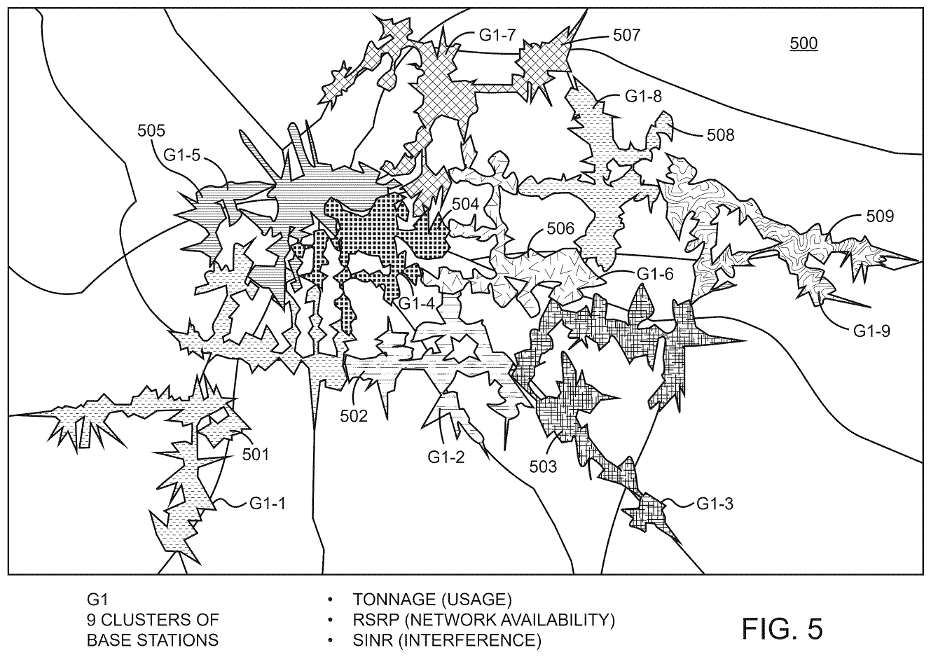

FIG. 5 is an example diagram illustrating expected wireless coverage provided by a first set of proposed wireless base station clusters as indicated by the first base station installation information associated with G1 as discussed herein.

As previously discussed, the installation management resource 140 can be configured to include the installation plan generator algorithm 141 to produce respective base station cluster plans G1, G2, G3, etc., based upon the combination of the network information 120 received as input 105 and corresponding input build criteria such as cluster build criteria 151, cluster build criteria 152, cluster build criteria 153, etc.

As shown in FIG. 5, and with reference to FIG. 1 as well, based on the network information 120 as well as the cluster build criteria 151 (indicating tonnage, SINR, and RSRP parameters in which to use as a basis to build respective clusters of wireless base stations providing different zones of wireless coverage in the geographical region 110), the installation management resource 140 and corresponding installation plan generator algorithm 141 produce the output 106-1 such as proposed cluster installation plan G1 including 9 clusters of wireless base stations (G1-1, G1-2, G1-3, G1-4, G1-5, G1-6, G1-7, G1-8, and G1-9) providing corresponding regions of wireless coverage in the geographical region 110.

The proposed cluster installation plan G1 in this example specifies multiple clusters of wireless base stations including base station cluster installation plan G1-1, base station cluster installation plan G1-2, base station cluster installation plan G1-3, . . . , base station cluster installation plan G1-9.

Further in this example, the installation plan information 121-1 associated with the base station cluster installation plan G1-1 generated by the installation plan generator algorithm 141 indicates installation information such as: a corresponding number of wireless base stations for installation in the geographical region 110, where and at what height to install each of the corresponding wireless base stations associated with a respective base station cluster, type of wireless base station to be installed, etc. The proposed cluster of wireless base stations as specified by the installation plan information 121-1 provides a first region of wireless coverage 501 in the geographical region 110.

The installation plan information 121-2 associated with the base station cluster installation plan G1-2 generated by the installation plan generator algorithm 141 indicates: a corresponding number of wireless base stations for installation in the geographical region 110, where and at what height to install each of the corresponding wireless base stations associated with a respective base station cluster, type of wireless base station to be installed, etc. Installation of the proposed cluster of wireless base stations as specified by the installation plan information 121-2 provides a region of wireless coverage 502 in the geographical region 110.

The installation plan information 121-3 associated with the base station cluster installation plan G1-3 generated by the installation plan generator algorithm 141 indicates: a corresponding number of wireless base stations for installation in the geographical region 110, where and at what height to install each of the corresponding wireless base stations associated with a respective base station cluster, types of wireless base stations to be installed, etc. The proposed cluster of wireless base stations as specified by the installation plan information 121-3 provides a region of wireless coverage 503 in the geographical region 110.

In a similar manner as discussed above, based on the selected parameters such as tonnage, SINR, and RSRP, the other installation plan information associated with the cluster plan G1 indicate attributes of installing corresponding base stations to implement for each of the different regions of wireless coverage 804, 805, 806, etc. For example, the installation plan information 121-4 indicates where to install a set of wireless base stations to provide the region of wireless coverage 804; the installation plan information 121-5 indicates where to install a respective set of wireless base stations by the region of wireless coverage 805; and so on.

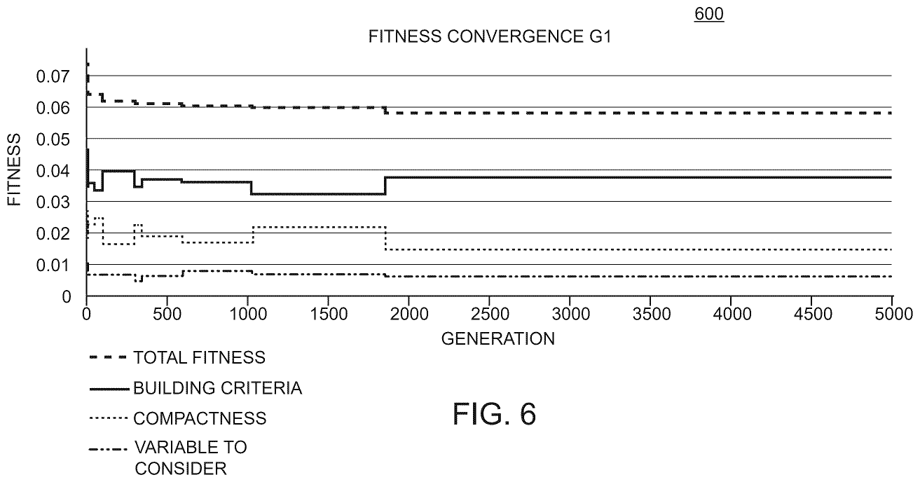

FIG. 6 is an example diagram illustrating fitness convergence associated with the first base station installation information as discussed herein.

Graph 600 illustrates fitness convergence associated with generation of the proposed cluster installation plan G1. The iterations of trying different locations and corresponding base stations in the different regions of wireless coverage with respect to the chosen parameters of interest including tonnage, SINR, and RSRP parameters as indicated by the cluster build criteria 151 results in convergence to best fit base stations used to produce the cluster installation plan G1.

FIG. 7 is an example diagram illustrating a graphical user interface indicating a second set of selected parameters for producing second base station installation information G2 as discussed herein.

In this example, the dashboard 700 (such as displayed on a respective display screen of the installation management resource 140) indicates the corresponding parameters associated with the cluster building criteria 151 for generation of the cluster plans G2. Additionally, the dashboard 700 indicates additional attributes associated with generation of the cluster plans G2.

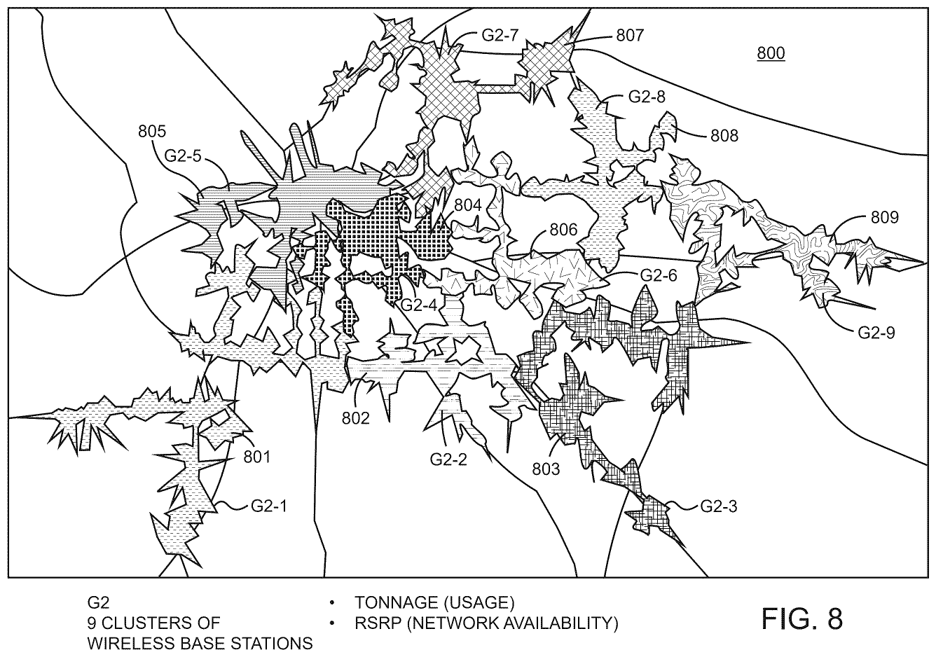

FIG. 8 is an example diagram illustrating expected wireless coverage provided by a second set of proposed wireless base stations as indicated by the second base station installation information as discussed herein.

As previously discussed, the installation management resource 140 can be configured to include the installation plan generator algorithm 141 to produce respective base station cluster plans G1, G2, G3, etc., based upon the combination of the network information 120 received as input 105 and corresponding input build criteria such as cluster build criteria 151, cluster build criteria 152, cluster build criteria 153, etc.

As shown in FIG. 8, and with reference to FIG. 1 as well, based on the network information 120 as well as the cluster build criteria 152 indicating tonnage (wireless service demand) and RSRP (wireless signal strength) parameters in which to use as a basis to build respective clusters of wireless base stations providing different zones of wireless coverage in the geographical region 110), the installation management resource 140 and corresponding installation plan generator algorithm 141 produce the output 106-2 such as proposed cluster installation plan G2 including 9 clusters of wireless base stations (G2-1, G2-2, G2-3, G2-4, G2-5, G2-6, G2-7, G2-8, G2-9) providing corresponding regions of wireless coverage in the geographical region 110.

The proposed cluster installation plan G2 in this example specifies multiple clusters of wireless base stations including base station cluster installation plan G2-1, base station cluster installation plan G2-2, base station cluster installation plan G2-3, . . . , base station cluster installation plan G2-9.

Further in this example, the installation plan information 122-1 associated with the base station cluster installation plan G2-1 generated by the installation plan generator algorithm 141 indicates: a corresponding number of wireless base stations for installation in the geographical region 110, where and at what height to install each of the corresponding wireless base stations associated with a respective base station cluster, type of wireless base station, etc. Installation of the proposed cluster of wireless base stations as specified by the installation plan information 122-1 will provide a first region of wireless coverage 802 in the geographical region 110.

The installation plan information 122-2 associated with the base station cluster installation plan G2-2 generated by the installation plan generator algorithm 141 indicates: a corresponding number of wireless base stations for installation in the geographical region 110, where and at what height to install each of the corresponding wireless base stations associated with a respective base station cluster, etc. The proposed cluster of wireless base stations as specified by the installation plan information 122-2 provides a region of wireless coverage 802 in the geographical region 110.

The installation plan information 122-3 associated with the base station cluster installation plan G2-3 generated by the installation plan generator algorithm 141 indicates: a corresponding number of wireless base stations for installation in the geographical region 110, where and at what height to install each of the corresponding wireless base stations associated with a respective base station cluster, etc. The proposed cluster of wireless base stations as specified by the installation plan information 122-3 provides a region of wireless coverage 803 in the geographical region 110.

In a similar manner as discussed above, the other installation plan information associated with the cluster plan G2 indicate corresponding base stations to implement for each of the different regions of wireless coverage 804, 805, 806, etc. For example, the installation plan information 122-4 indicates where to install base stations to provide the region of wireless coverage 804; the installation plan information 122-5 indicates where to install base stations to provide the region of wireless coverage 805; and so on.

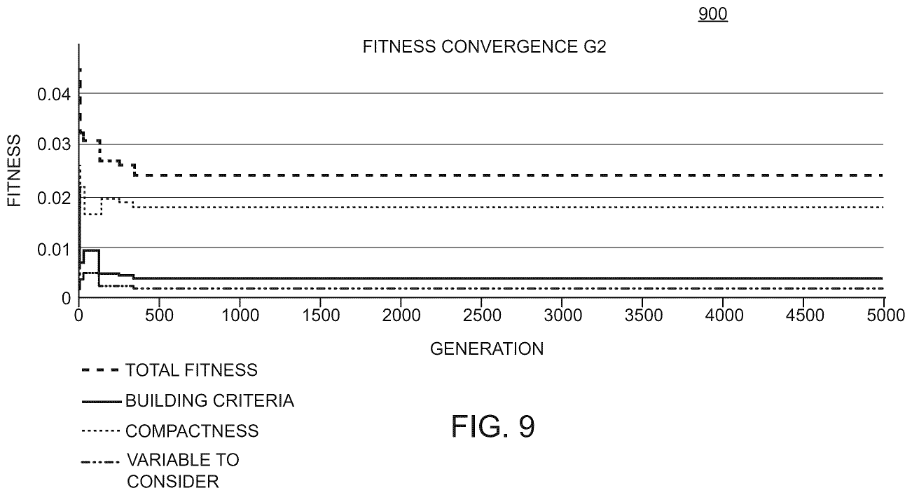

FIG. 9 is an example diagram illustrating fitness convergence associated with the second base station installation information as discussed herein.

Graph 900 illustrates fitness convergence associated with generation of the proposed cluster installation plan G2. The iterations of trying different locations and corresponding base stations in the different regions of wireless coverage with respect to the chosen parameters of interest including tonnage and RSRP parameters as indicated by the cluster build criteria 152 results in convergence to best fit base stations used to produce the cluster installation plan G2.

FIG. 10 is an example diagram illustrating a graphical user interface indicating a third set of selected parameters for producing the third base station installation information as discussed herein.

In this example, the dashboard 1000 (such as displayed on a respective display screen of the installation management resource 140) indicates the corresponding parameters associated with the cluster building criteria 153 for generation of the cluster plans G3. Additionally, the dashboard 1000 indicates additional attributes associated with generation of the cluster plans G3.

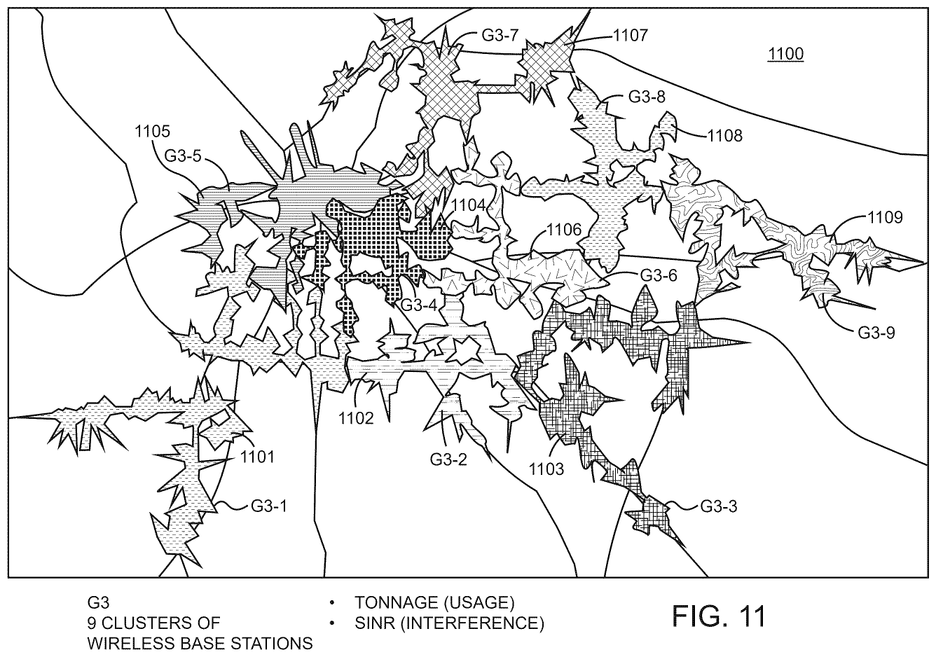

FIG. 11 is an example diagram illustrating expected wireless coverage provided by a third set of proposed wireless base stations as indicated by the third base station installation information G3 as discussed herein.

As shown in FIG. 11, and with reference to FIG. 1 as well, based on the network information 120 as well as the cluster build criteria 153 indicating tonnage and SINR parameters in which to use as a basis to build respective clusters of wireless base stations providing different zones of wireless coverage in the geographical region 110, the installation management resource 140 and corresponding installation plan generator algorithm 141 produce the output 106-3 such as proposed cluster installation plan G3 including 9 clusters of base stations (G3-1, G3-2, G3-3, G3-4, G3-5, G3-6, G3-7, G3-8, G3-9) providing corresponding regions of wireless coverage in the geographical region 110.

The proposed cluster installation plan G3 in this example specifies multiple clusters of wireless base stations including base station cluster installation plan G3-1, base station cluster installation plan G3-2, base station cluster installation plan G3-3, . . . , base station cluster installation plan G3-9.

Further in this example, the installation plan information 123-1 associated with the base station cluster installation plan G3-1 generated by the installation plan generator algorithm 141 indicates: a corresponding number of wireless base stations for installation in the geographical region 110, where and at what height to install each of the corresponding wireless base stations associated with a respective base station cluster, types of wireless base stations for installation, etc. Installation of the proposed cluster of wireless base stations as specified by the installation plan information 123-1 is expected to provide a first region of wireless coverage 1101 in the geographical region 110.

The installation plan information 123-2 associated with the base station cluster installation plan G3-2 generated by the installation plan generator algorithm 141 indicates: a corresponding number of wireless base stations for installation in the geographical region 110, where and at what height to install each of the corresponding wireless base stations associated with a respective base station cluster, types of wireless base stations, etc. The proposed cluster of wireless base stations as specified by the installation plan information 123-2 provides an expected region of wireless coverage 1102 in the geographical region 110.

The installation plan information 123-3 associated with the base station cluster installation plan G3-3 generated by the installation plan generator algorithm 141 indicates: a corresponding number of wireless base stations for installation in the geographical region 110, where and at what height to install each of the corresponding wireless base stations associated with a respective base station cluster, types of wireless base stations, etc. The proposed cluster of wireless base stations as specified by the installation plan information 123-3 provides an expected region of wireless coverage 1103 in the geographical region 110.

In a similar manner as discussed above, the other installation plan information associated with the cluster plan G3 indicate corresponding base stations to implement for each of the different regions of wireless coverage 1104, 1105, 1106, etc. For example, the installation plan information 123-4 indicates where to install base stations to provide the region of wireless coverage 1104; the installation plan information 123-5 indicates where to install base stations to provide the region of wireless coverage 1105; and so on.

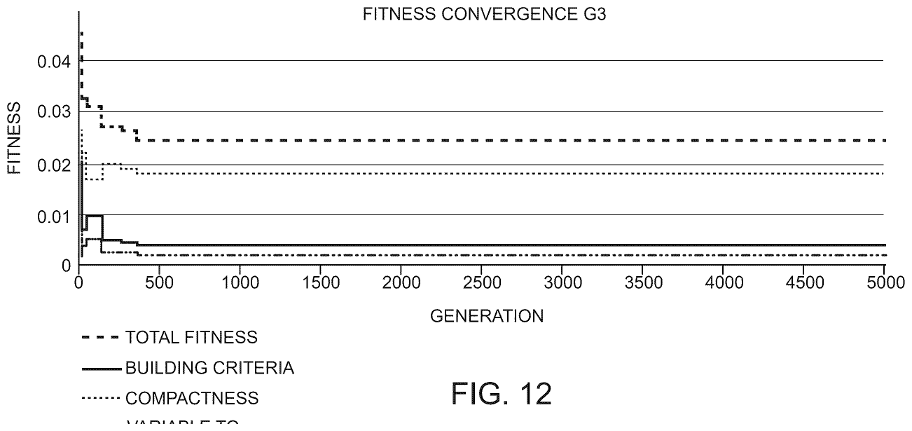

FIG. 12 is an example diagram illustrating fitness convergence associated with the third base station installation information as discussed herein.

Graph 1200 illustrates fitness convergence associated with generation of the proposed cluster installation plan G3. The iterations of trying different locations and corresponding base stations in the different regions of wireless coverage with respect to the chosen parameters of interest including tonnage and SINR parameters as indicated by the cluster build criteria 153 results in convergence to best fit base stations used to produce the cluster installation plan G3.

With reference to a combination of the FIGS. 5, 8, and 11, it is noted that the region of wireless coverage 501, region of wireless coverage 801, and region of wireless coverage 1101, may be almost identical, but not exactly. The region of wireless coverage 502, region of wireless coverage 802, and region of wireless coverage 1102, may be similar, but not exactly. The region of wireless coverage 503, region of wireless coverage 803, and region of wireless coverage 1103, may be similar, but not exactly t, and so on. The slight differences associated with the corresponding regions of wireless coverage may occur due to the installation plan generator algorithm 141 placing wireless base stations at different locations and in different numbers based on the corresponding initial criteria (cluster build criteria) used to produce each of the different installation plans.

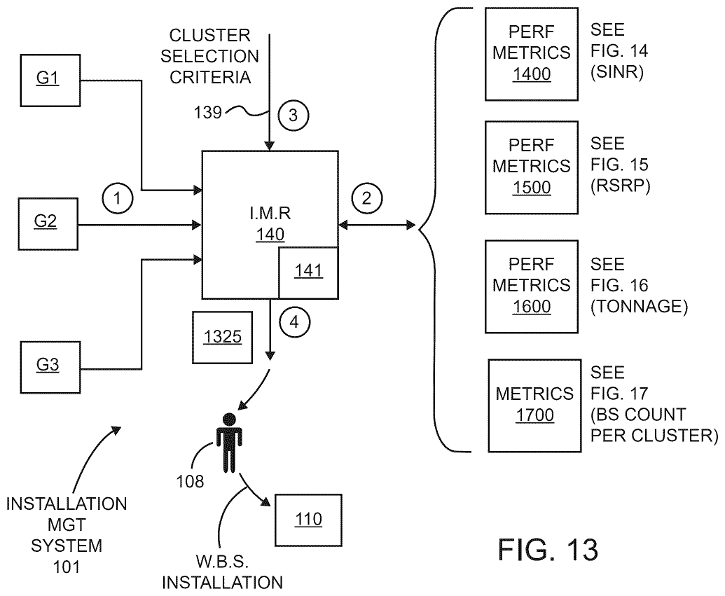

FIG. 13 is an example diagram illustrating generation of performance metrics associated with the multiple base station installation plans and selection of a base station installation plan based on selection criteria as discussed herein.

As previously discussed, the installation plan generator algorithm 141 and corresponding installation management resource 140 produces the respective installation plans G1, G2, G3, etc.

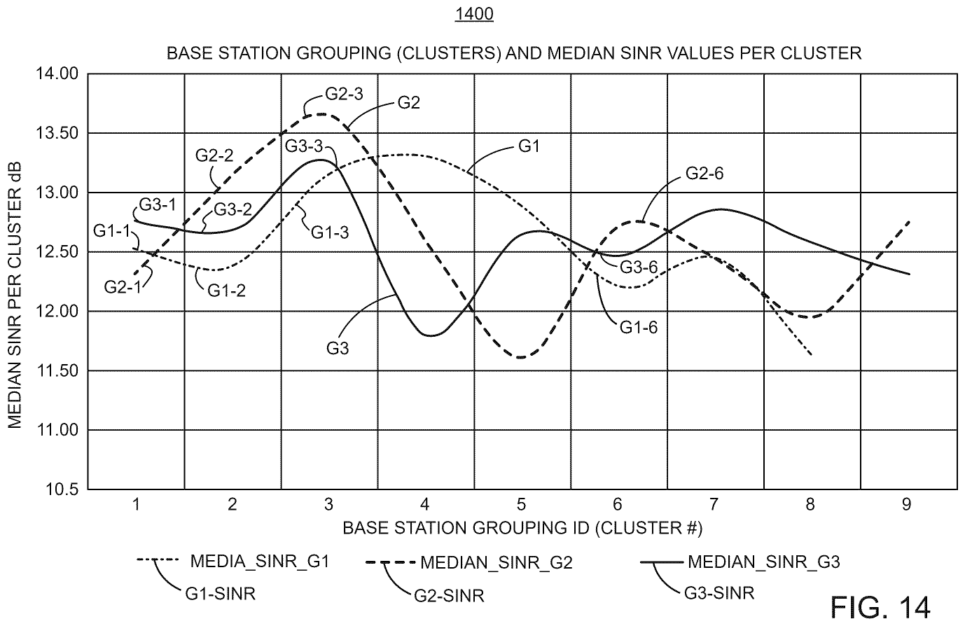

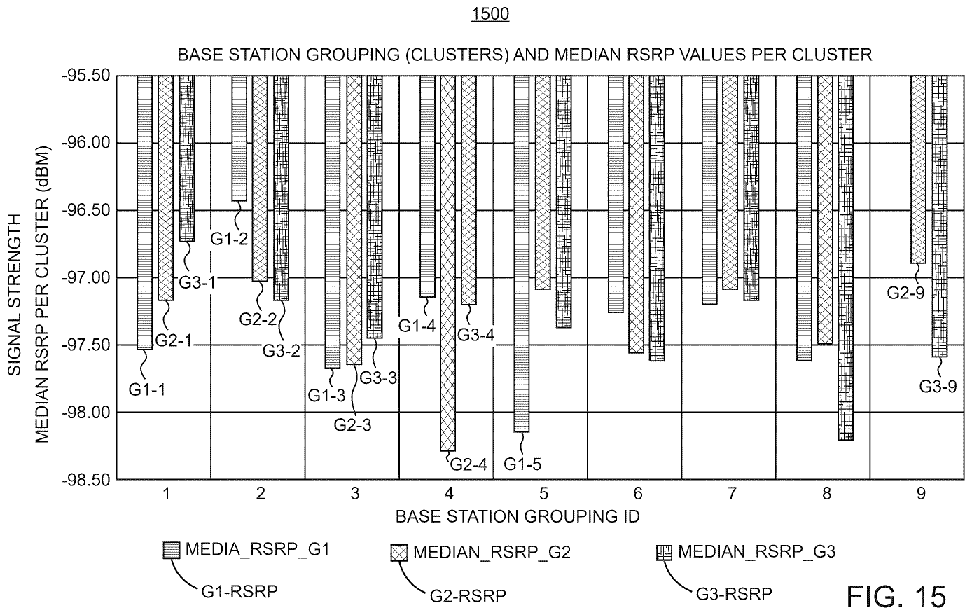

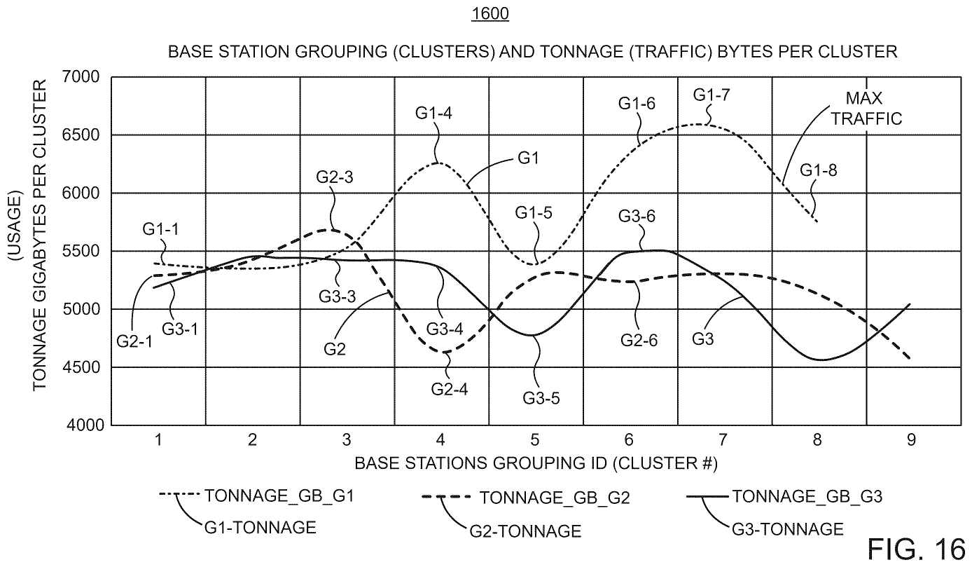

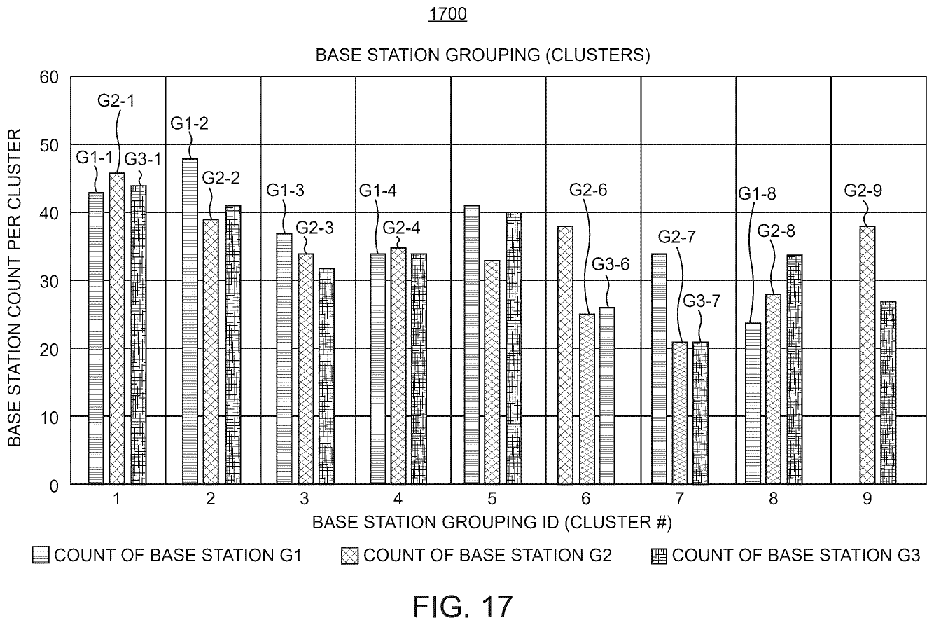

As shown in FIG. 13, in processing operation #1, the installation management resource 140 receives and analyzes the installation plans G1, G2, G3, etc. Based on the received plans, the installation management resource 140 generates the performance metrics 1400 (see FIG. 14), performance metrics 1500 (see FIG. 15), performance metrics 1600 (see FIG. 16), installation metrics 1700 (see FIG. 17), etc.

Details of associated with generating each of the different metrics is discussed below.

FIG. 14 is an example diagram illustrating first performance information associated with the multiple base station installation plans as discussed herein.

As previously discussed, each of the respective cluster installation plans G1, G2, G3, etc., is generated based upon corresponding cluster build criteria 151, 152, 153, etc. The graph 1400 illustrates performance of each wireless base station cluster within each of the different cluster installation plans G1, G2, and G3.

For example, the x-axis of graph 1400 illustrates the corresponding cluster number within the cluster installation plan; the y-axis of graph 1400 illustrates a median SINR metric (interference information) associated with each cluster in the respective plan.

More specifically, the metric G1-SINR (curved line) in graph 1400 indicates that: i) the cluster G1-1 associated with the cluster installation plan G1 (which supports the corresponding region of wireless coverage 501) provides a median SINR of around 12.5 dB to any mobile communication devices at different locations within the region of wireless coverage 501; ii) the cluster G1-2 associated with the cluster installation plan G1 (which supports the corresponding region of wireless coverage 502) provides a median SINR of around 12.3 dB to any mobile communication devices at different locations within the region of wireless coverage 502; iii) the cluster G1-3 associated with the cluster installation plan G1 (which supports the corresponding region of wireless coverage 503) provides a median SINR of around 13.2 dB to any mobile communication devices at different locations within the region of wireless coverage 503; iv) the cluster G1-4 associated with the cluster installation plan G1 (which supports the corresponding region of wireless coverage 504) provides a median SINR of around 13.3 dB to any mobile communication devices at different locations within the region of wireless coverage 504; and so on.

The metric G2-SINR (curved line) in graph 1400 indicates that: i) the cluster G2-1 associated with the cluster installation plan G2 (which supports the corresponding region of wireless coverage 801) provides a median SINR of around 12.3 dB to any mobile communication devices at different locations within the region of wireless coverage 801; ii) the cluster G2-2 associated with the cluster installation plan G2 (which supports the corresponding region of wireless coverage 802) provides a median SINR of around 13.2 dB to any mobile communication devices at different locations within the region of wireless coverage 802; iii) the cluster G2-3 associated with the cluster installation plan G2 (which supports the corresponding region of wireless coverage 803) provides a median SINR of around 13.6 dB to any mobile communication devices at different locations within the region of wireless coverage 803; iv) the cluster G2-4 associated with the cluster installation plan G2 (which supports the corresponding region of wireless coverage 804) provides a median SINR of around 12.5 dB to any mobile communication devices at different locations within the region of wireless coverage 804; and so on.

The metric G3-SINR (curved line) in graph 1400 indicates that: i) the cluster G3-1 associated with the cluster installation plan G3 (which supports the corresponding region of wireless coverage 1101) provides a median SINR of around 12.7 dB to any mobile communication devices at different locations within the region of wireless coverage 1101; ii) the cluster G3-2 associated with the cluster installation plan G3 (which supports the corresponding region of wireless coverage 1102) provides a median SINR of around 12.7 dB to any mobile communication devices at different locations within the region of wireless coverage 1102; iii) the cluster G3-3 associated with the cluster installation plan G3 (which supports the corresponding region of wireless coverage 1103) provides a median SINR of around 13.2 dB to any mobile communication devices at different locations within the region of wireless coverage 1103; iv) the cluster G3-4 associated with the cluster installation plan G3 (which supports the corresponding region of wireless coverage 1104) provides a median SINR of around 11.8 dB to any mobile communication devices at different locations within the region of wireless coverage 1104; and so on.

Accordingly, the graph 1400 illustrates the different performances associated with each of the proposed clusters of base stations for these specific metric of SINR (i.e., wireless interference).

FIG. 15 is an example diagram illustrating a second performance information associated with the multiple base station installation plans as discussed herein.

As previously discussed, each of the respective cluster installation plans G1, G2, G3, etc., is generated based upon corresponding cluster build criteria 151, 152, 153, etc. The graph 1500 illustrates performance of each wireless base station cluster within each of the different cluster installation plans G1, G2, and G3. The wireless signal strength performance indicates a respective wireless signal strength provided by each respective cluster to the corresponding region of wireless coverage.

For example, the x-axis of graph 1500 illustrates the corresponding cluster number within the cluster installation plan; the y-axis of graph 1500 illustrates a median RSRP metric (wireless signal strength metric) associated with each cluster in the respective plan.

More specifically, the metric G1-RSRP (such as bars, one for each cluster) in graph 1500 indicates that: i) the cluster G1-1 associated with the first cluster in the cluster installation plan G1 (which supports the corresponding region of wireless coverage 501) provides a median RSRP of around-97.5 dBm to any mobile communication devices at different locations within the region of wireless coverage 501; ii) the cluster G1-2 associated with the cluster installation plan G1 (which supports the corresponding region of wireless coverage 502) provides a median RSRP of around-96.4 dBm to any mobile communication devices at different locations within the region of wireless coverage 502; iii) the cluster G1-3 associated with the cluster installation plan G1 (which supports the corresponding region of wireless coverage 503) provides a median RSRP of around-97.7 dBm to any mobile communication devices at different locations within the region of wireless coverage 503; iv) the cluster G1-4 associated with the cluster installation plan G1 (which supports the corresponding region of wireless coverage 504) provides a median RSRP of around-97.2 dBm to any mobile communication devices at different locations within the region of wireless coverage 504; and so on.

The metric G2-RSRP (bars) in graph 1500 indicates that: i) the cluster G2-1 associated with the cluster installation plan G2 (which supports the corresponding region of wireless coverage 801) provides a median RSRP of around −97.2 dBm to any mobile communication devices at different locations within the region of wireless coverage 801; ii) the cluster G2-2 associated with the cluster installation plan G2 (which supports the corresponding region of wireless coverage 802) provides a median RSRP of around −97.0 dBm to any mobile communication devices at different locations within the region of wireless coverage 802; iii) the cluster G2-3 associated with the cluster installation plan G2 (which supports the corresponding region of wireless coverage 803) provides a median RSRP of around −97.6 dBm to any mobile communication devices at different locations within the region of wireless coverage 803; iv) the cluster G2-4 associated with the cluster installation plan G2 (which supports the corresponding region of wireless coverage 804) provides a median RSRP of around −98.3 dBm to any mobile communication devices at different locations within the region of wireless coverage 804; and so on.

The metric G3-RSRP (bars) in graph 1500 indicates that: i) the cluster G3-1 associated with the cluster installation plan G3 (which supports the corresponding region of wireless coverage 1101) provides a median RSRP of around −96.7 dBm to any mobile communication devices at different locations within the region of wireless coverage 1101; ii) the cluster G3-2 associated with the cluster installation plan G3 (which supports the corresponding region of wireless coverage 1102) provides a median RSRP of around −97.2 dBm to any mobile communication devices at different locations within the region of wireless coverage 1102; iii) the cluster G3-3 associated with the cluster installation plan G3 (which supports the corresponding region of wireless coverage 1103) provides a median RSRP of around −97.5 dBm to any mobile communication devices at different locations within the region of wireless coverage 1103; iv) the cluster G3-4 associated with the cluster installation plan G3 (which supports the corresponding region of wireless coverage 1104) provides a median RSRP of around −97.2 dBm to any mobile communication devices at different locations within the region of wireless coverage 1104; and so on.

Accordingly, the graph 1500 illustrates the different performances associated with each of the proposed clusters of base stations for these specific metric of RSRP (signal strength).

FIG. 16 is an example diagram illustrating third performance information associated with the multiple base station installation plans as discussed herein.

As previously discussed, each of the respective cluster installation plans G1, G2, G3, etc., is generated based upon corresponding cluster build criteria 151, 152, 153, etc. The graph 1600 illustrates performance of each wireless base station cluster within each of the different cluster installation plans G1, G2, and G3.

For example, the x-axis of graph 1600 illustrates the corresponding cluster number within the cluster installation plan; the y-axis of graph 1600 illustrates tonnage or gigabytes metric (usage demand by different users in each region of wireless coverage) associated with each cluster in the respective plans G1, G2, and G3.

More specifically, the metric G1-TONNAGE (curved line) in graph 1600 indicates that: i) the cluster G1-1 associated with the cluster installation plan G1 (which supports the corresponding region of wireless coverage 501) provides a median TONNAGE of around 5400 gigabytes to mobile communication devices at different locations within the region of wireless coverage 501; ii) the cluster G1-2 associated with the cluster installation plan G1 (which supports the corresponding region of wireless coverage 502) provides a median TONNAGE of around 5400 gigabytes to any mobile communication devices at different locations within the region of wireless coverage 502; iii) the cluster G1-3 associated with the cluster installation plan G1 (which supports the corresponding region of wireless coverage 503) provides a median TONNAGE of around 5500 gigabytes to any mobile communication devices at different locations within the region of wireless coverage 503; iv) the cluster G1-4 associated with the cluster installation plan G1 (which supports the corresponding region of wireless coverage 504) provides a median TONNAGE of around 6200 gigabytes to any mobile communication devices at different locations within the region of wireless coverage 504; and so on.

The metric G2-TONNAGE (curved line) in graph 1600 indicates that: i) the cluster G2-1 associated with the cluster installation plan G2 (which supports the corresponding region of wireless coverage 801) provides a median TONNAGE (wireless service demand) of around 5300 gigabytes to any mobile communication devices at different locations within the region of wireless coverage 801; ii) the cluster G2-2 associated with the cluster installation plan G2 (which supports the corresponding region of wireless coverage 802) provides a median TONNAGE of around 5400 gigabytes to any mobile communication devices at different locations within the region of wireless coverage 802; iii) the cluster G2-3 associated with the cluster installation plan G2 (which supports the corresponding region of wireless coverage 803) provides a median TONNAGE of around 5700 gigabytes to any mobile communication devices at different locations within the region of wireless coverage 803; iv) the cluster G2-4 associated with the cluster installation plan G2 (which supports the corresponding region of wireless coverage 804) provides a median TONNAGE of around 4600 gigabytes to any mobile communication devices at different locations within the region of wireless coverage 804; and so on.

The metric G3-TONNAGE (curved line) in graph 1600 indicates that: i) the cluster G3-1 associated with the cluster installation plan G3 (which supports the corresponding region of wireless coverage 1101) provides a median TONNAGE of around 5200 gigabytes to any mobile communication devices at different locations within the region of wireless coverage 1101; ii) the cluster G3-2 associated with the cluster installation plan G3 (which supports the corresponding region of wireless coverage 1102) provides a median TONNAGE of around 5500 gigabytes to any mobile communication devices at different locations within the region of wireless coverage 1102; iii) the cluster G3-3 associated with the cluster installation plan G3 (which supports the corresponding region of wireless coverage 1103) provides a median TONNAGE of around 5400 gigabytes to any mobile communication devices at different locations within the region of wireless coverage 1103; iv) the cluster G3-4 associated with the cluster installation plan G3 (which supports the corresponding region of wireless coverage 1104) provides a median TONNAGE of around 5300 gigabytes to any mobile communication devices at different locations within the region of wireless coverage 1104; and so on.

Accordingly, the graph 1600 illustrates the different performances associated with each of the proposed clusters of base stations for these specific metric of TONNAGE (expected wireless traffic and demand for wireless services provided by wireless base stations in a respective cluster).

FIG. 17 is an example diagram illustrating fourth performance information associated with the multiple base station installation plans as discussed herein.

As previously discussed, each of the respective cluster installation plans G1, G2, G3, etc., is generated based upon corresponding cluster build criteria 151, 152, 153, etc. The graph 1700 illustrates a number of proposed wireless base stations in each wireless base station cluster within each of the different cluster installation plans G1, G2, and G3. In other words, as indicated by the graph 1700, the proposed cluster installation plans indicate a different number of wireless base stations to install to support each corresponding region of wireless coverage.

For example, the x-axis of graph 1700 illustrates the corresponding cluster number of proposed wireless base stations within the cluster installation plan; the y-axis of graph 1700 illustrates a number of wireless base stations for installation in each respective proposed cluster plan.

More specifically, the metric G1-COUNT (such as bars, one for each cluster) in graph 1700 indicates that: i) the cluster G1-1 associated with the first cluster in the cluster installation plan G1 (which supports the corresponding region of wireless coverage 501) proposes installation of a COUNT of 42 wireless base stations to support the corresponding region of wireless coverage 501; ii) the cluster G1-2 associated with the cluster installation plan G1 (which supports the corresponding region of wireless coverage 502) proposes installation of a COUNT of 48 wireless base stations to support the corresponding region of wireless coverage 502; iii) the cluster G1-3 associated with the cluster installation plan G1 (which supports the corresponding region of wireless coverage 503) proposes installation of a COUNT of 37 wireless base stations to support the corresponding region of wireless coverage 503; iv) the cluster G1-4 associated with the cluster installation plan G1 (which supports the corresponding region of wireless coverage 504) proposes installation of a COUNT of 33 wireless base stations to support the corresponding region of wireless coverage 504; and so on.

The metric G2-COUNT (such as bars, one for each cluster) in graph 1700 indicates that: i) the cluster G2-1 associated with the cluster installation plan G2 (which supports the corresponding region of wireless coverage 801) proposes installation of a COUNT of 45 wireless base stations to support the corresponding region of wireless coverage 801; ii) the cluster G2-2 associated with the cluster installation plan G2 (which supports the corresponding region of wireless coverage 802) proposes installation of a COUNT 39 wireless base stations to support the corresponding region of wireless coverage 802; iii) the cluster G2-3 associated with the cluster installation plan G2 (which supports the corresponding region of wireless coverage 803) proposes installation of a COUNT of 34 wireless base stations to support the corresponding region of wireless coverage 803; iv) the cluster G2-4 associated with the cluster installation plan G2 (which supports the corresponding region of wireless coverage 804) proposes installation of a COUNT of 35 wireless base stations to support the corresponding region of wireless coverage 804; and so on.

The metric G3-COUNT (such as bars, one for each cluster) in graph 1500 indicates that: i) the cluster G3-1 associated with the cluster installation plan G3 (which supports the corresponding region of wireless coverage 1101) proposes installation of a COUNT of 43 wireless base stations to support the corresponding region of wireless coverage 1101; ii) the cluster G3-2 associated with the cluster installation plan G3 (which supports the corresponding region of wireless coverage 1102) proposes installation of a COUNT of 41 wireless base stations to support the corresponding region of wireless coverage 1102; iii) the cluster G3-3 associated with the cluster installation plan G3 (which supports the corresponding region of wireless coverage 1103) proposes installation of a COUNT of 31 wireless base stations to support the corresponding region of wireless coverage 1103; iv) the cluster G3-4 associated with the cluster installation plan G3 (which supports the corresponding region of wireless coverage 1104) proposes installation of a COUNT of 34 wireless base stations to support the corresponding region of wireless coverage 1104; and so on.

Accordingly, the graph 1700 illustrates the different performances associated with each of the proposed clusters of base stations for the specific metric of COUNT (a.k. a., number of wireless base stations as previously discussed).

Referring again to FIG. 13, it is noted that in processing operation #3, the installation management resource 140 as discussed herein can be configured to receive/access the cluster selection criteria 139 specifying further parameters in which to apply to each of the different performance metrics (such as 1400, 1500, 1600, 1700, etc.) and installation plan options G1, G2, G3, to select which of the multiple clusters to install in the geographical region 110.

In other words, the wireless network service provider may decide to install less than all of the clusters of wireless base stations in the geographical region 110. For example, the installation management resource 140 can be configured to use the cluster selection criteria 139 as a basis in which to make a final selection of one or more clusters of wireless base stations (as indicated by the final installation plan 1325) to install in the geographical region 110.

As a more specific example, the cluster selection criteria 139 may indicate to install a cluster of wireless base stations using only installation plan G2, and where the selected one or more cluster of wireless base stations and corresponding regions of wireless coverage provide greater than a threshold level of 13.0 for the SINR metric in graph 1400.

Based on the cluster selection criteria 139 indicating the threshold level of 13.0 for the interference metric, using graph 1400 FIG. 14, the installation management resource 140 checks where the metric G2-SINR indicates that corresponding one or more clusters of wireless base stations provide greater than the threshold level of 13.0. In such an instance, the installation management resource 140 therefore selects cluster G2-2 (as defined by the wireless base station installation 122-2) and the cluster G2-3 (as defined by the wireless base station installation information 122-3) because they both provide a median SINR value greater than 13 for the G2 installation option. In such an instance, the installation management resource 140 produces the final installation plan 1325 to include the wireless base station installation information 122-2 and the wireless base stations lacing information 122-3.

As further shown in FIG. 13, the one or more installation technicians 108 receive the final installation plan 1325 and install corresponding wireless base stations associated with the installation plan 122-2 and the installation plan 122-3 in the geographical region 110. Accordingly, the wireless network service provider installing the respective wireless base stations in the geographical region may decide to install only a portion of the clusters of wireless base stations (cluster associated with 122-2 and cluster associated with 122-3) in the installation plan G2.

As another example, in operation #3 of FIG. 13, note that the cluster installation management resource 140 may receive cluster selection criteria 139 indicating to select wireless base station clusters (amongst the 3 different installation plan options G1, G2, G3) providing a signal strength greater than −97 dBm to respective users and corresponding regions of wireless coverage (9 regions of wireless coverage per each of the installation options G1, G2, G3). In such an instance, the cluster installation management resource 140 uses the graph 1500 to determine that cluster G3-1 (and corresponding installation plan 123-1 providing region of wireless coverage 1101), cluster G1-2 (and corresponding installation plan 121-2 providing region of wireless coverage 502), and cluster G2-9 (and corresponding installation plan 122-9 providing region of wireless coverage 809), each provide a signal strength in respective regions of wireless coverage above the threshold level of −97 dBm. In such an instance, the installation management resource 140 selects each of these clusters and corresponding plan information (G3-1 and corresponding plan 123-1, Q1-2 and corresponding plan 121-2, and G2-9 and corresponding plan 122-9) for inclusion in the final installation plan 1325 for subsequent installation of a respective wireless base station clusters in the geographical region 110.

As yet another example, in operation #3 of FIG. 13, the cluster installation management resource 140 may receive cluster selection criteria 139 indicating to select wireless base station clusters (amongst just the installation plan G2) providing a signal to noise ratio greater than 12.5 SINR in the corresponding regions of wireless coverage is shown in graph 800 in FIG. 8. In such an instance, the cluster installation management resource 140 uses the graph 1400 to determine that, for the G2 option, cluster G2-2 (and corresponding installation plan 122-2 providing region of wireless coverage 802), cluster G2-3 (and corresponding installation plan 122-3 providing region of wireless coverage 803), cluster G2-4 (and corresponding installation plan 122-4 providing region of wireless coverage 804), cluster G2-6 (and corresponding installation plan 122-6 providing region of wireless coverage 806), cluster G2-9 (and corresponding installation plan 122-9 providing region of wireless coverage 809), each provide a SINR strength in respective regions of wireless coverage greater than the threshold level of 12.5. In such an instance, the installation management resource 140 selects each of these clusters (G2-2, G2-3, G2-4, G2-6, and G2-9) and corresponding plan information for inclusion in the final installation plan 1325 for subsequent installation of a respective wireless base station clusters in the geographical region 110.

Still further, the selection criteria 139 supplied by the service provider installing the respective one or more clusters of wireless base stations in the geographical region 110 can be configured to indicate multiple parameters in which to select amongst the different base station cluster options G1, G2, G3. For example, assume that the cluster selection criteria 139 indicates to select a wireless base station cluster plan that requires less than 30 wireless base stations for the respective cluster as well as provides an anticipated received signal strength value (RSRP) of greater than −97.5 dBm. As shown in FIG. 17 and corresponding graph 1700, the cluster installation plans requiring less than 30 wireless base stations include a set of installation plans G2-6, G3-6, G2-7, G3-7, G1-8, G2-8, G2-9, and G3-9. As shown in FIG. 15 and corresponding graph 1500, the cluster installation plans providing greater than or equal to −97.0 dBm (for the set of installation plans G2-6, G3-6, G2-7, G3-7, G1-8, G2-8, G2-9, and G3-9) include G2-9 (installation plan 122-9 providing region of wireless coverage 809). In such an instance, the installation management resource 140 produces the final installation plan 1325 to include only the installation plan G2-9 (installation plan 122-9 providing region of wireless coverage 809.

As yet a further example, the selection criteria 139 supplied by the service provider installing the respective one or more clusters of wireless base stations in the geographical region 110 can be configured to indicate a desire to implement clusters in the geographical region only for the option G2 and only for those installation plans associated with G2 that that require less than 30 wireless base stations. For example, assume that the cluster selection criteria 139 indicates to select a wireless base station cluster plan that requires less than 30 wireless base stations for option G2. As shown in FIG. 17 and corresponding graph 1700, the cluster installation plans requiring less than 30 wireless base stations associate option G2 include a set of installation plans G2-6, G2-7, G2-8, and G2-9. In such an instance, the installation management resource 140 produces the final installation plan 1325 to include the cluster installation plan a set of installation plans G2-6 (installation plan 122-6 providing region of wireless coverage 806), G2-7 (installation plan 122-7 providing region of wireless coverage 807), G2-8 (installation plan 122-8 providing region of wireless coverage 808), and G2-9 (installation plan 122-9 providing region of wireless coverage 809).

Thus, from the above 3 cluster options (G1,G2,G3), appropriate clustering technique can be approached as per business needs of the wireless network service provider implementing any of the multiple mobile clusters of the wireless base stations in the geographical region 110 or other geographical regions. As another example, if the service provider wishes to implement clusters having a lower interference, the service provider can generate the cluster selection criteria 139 resulting in selection of the clusters associated with cluster installation plan G3, which provides the lowest interference as indicated by the graph 1400 and FIG. 14.

Yet further, when the service provider may choose to implement a traffic focused approach with regards to clusters providing the highest amount of tonnage (see graph 1600 in FIG. 16 indicating that the installation options G1 across corresponding clusters G1-1, G1-2, . . . , G1-7, G1-8 overall provide the greatest data throughput capability), in accordance with the cluster selection criteria 139 indicating same, the installation management resource 140 may select G1, where 8 clusters (grouping of base stations associate with clusters G1-1, G1-2, . . . , G1-7, G1-8) can be used for network deployment order. All of the above 3 options will also help maintain contiguity in order to have extremely better user experience and hence network revenue.

As another example, the cluster selection criteria 139 may indicate to select inflation of clusters of wireless base stations that provide the highest SINR value for each region of wireless coverage. For example, as previously discussed, each of the region of wireless coverage 501, 801, and 1101, provide approximately the same coverage; each of the regions of wireless coverage 502, 802, and 1102 provide approximately the same wireless coverage; and so on. Based on the selection criteria 139 in the graph 1400 in FIG. 14, the installation management resource 140 would select the highest cluster each corresponding region of wireless coverage or, more specifically, cluster G3-1, G2-2, G2-3, G1-4, G1-5, G2-6, G3-7, G3-8, and G2-9 for installation in the geographical region 110.

Accordingly, deploying the network of clusters of wireless base stations as further selected in accordance with the cluster selection criteria 139 and as indicated by the final installation plan 1325 helps to maintain the user experience across the network by having interference profile almost same in all the clusters.

As further shown, and as previously discussed, the final installation plan 1325 (indicating one or more cluster installation plans selected from the different cluster options G1, G2, G3, etc.) is supplied to one or more technicians 108, which then install the wireless base stations in accordance with the final installation plan 1325 in the geographical region 110.

Thus, as previously discussed, installation of the wireless base stations in accordance with the final installation plan may include installing one or more of the proposed clusters in the geographical region 110. Further, it is noted again that each of the clusters of wireless base stations is potentially configured to provide contiguous wireless coverage in that corresponding region of wireless coverage such that users traveling through the cluster do not need to hand off to a second network.

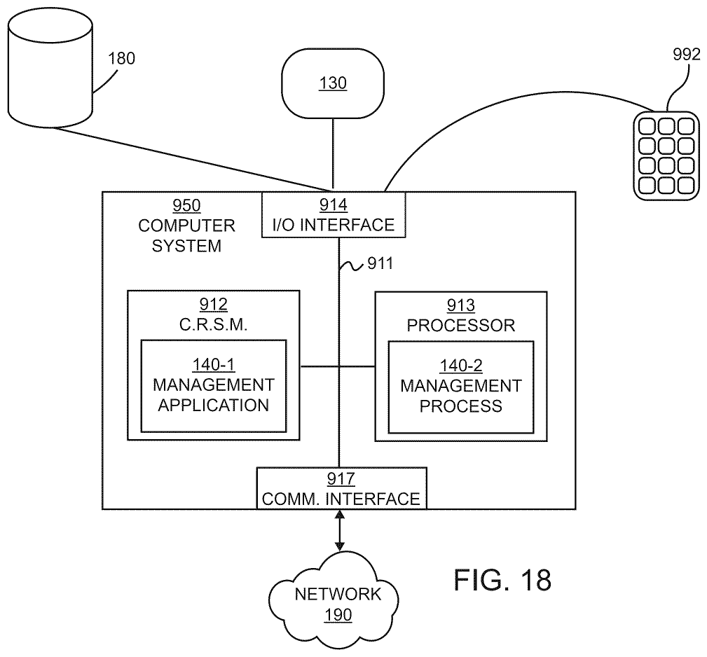

FIG. 18 is an example block diagram of a computer system for implementing any of the operations as discussed herein.

Note that any of the resources (such as installation management system 101, installation management resource 140, installation plan generator algorithm 141, etc.) as discussed herein can be configured to include computer processor hardware and/or corresponding executable instructions to carry out the different operations as discussed herein.

For example, as shown, computer system 950 of the present example includes interconnect 911 coupling computer readable storage media 912 such as computer readable storage hardware, a non-transitory type of media (which can be any suitable type of hardware storage medium in which digital information can be stored and or retrieved), a processor 913 (computer processor hardware), I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one example, the computer readable storage medium 912 is computer readable storage hardware that stores instructions and/or data.

As shown, computer readable storage media 912 can be encoded with management application 140-1 (e.g., including instructions) in a respective wireless station to carry out any of the operations as discussed herein.

During operation of one example, processor 913 accesses computer readable storage media 912 via the use of interconnect 911 in order to launch, run, execute, interpret or otherwise perform the instructions in management application 140-1 stored on computer readable storage medium 912. Execution of the management application 140-1 (configuration management application) produces management process 140-2 (configuration management process) to carry out any of the operations and/or processes as discussed herein.

Those skilled in the art will understand that the computer system 950 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

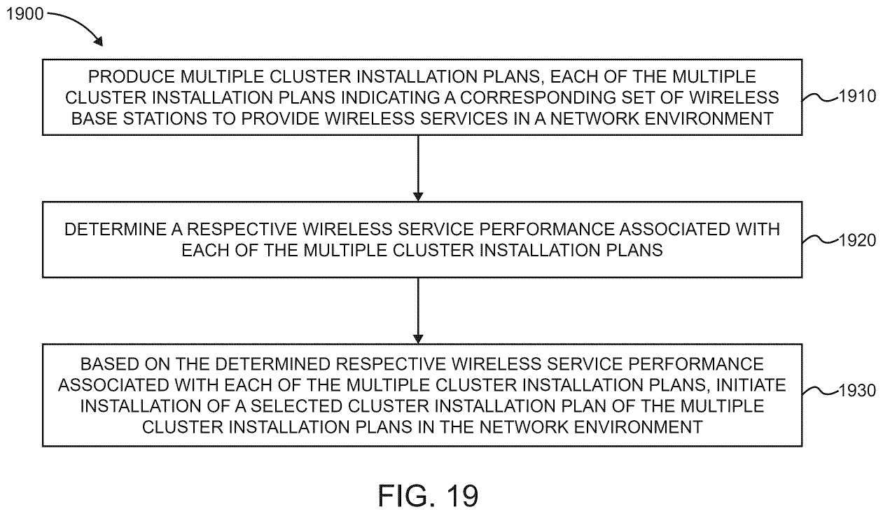

Functionality supported by the different resources will now be discussed via flowchart in FIG. 19. Note that the steps in the flowcharts below can be executed in any suitable order.

FIG. 19 is a flowchart 1900 illustrating an example method according to examples herein. Note that there will be some overlap with respect to concepts as discussed above because the flowchart 1900 captures the general ideas as previously presented.

In processing operation 1910, the installation management resource 140 produces multiple base station cluster installation plans G1, G2, G3, etc., where each of the multiple base station cluster installation plans indicates a corresponding set of wireless base stations to provide wireless services in a network environment.

In processing operation 1920, the management resource 140 determines a respective wireless service performance associated with each of the multiple cluster installation plans.

In processing operation 1930, based on the determined respective wireless service performance associated with each of the multiple cluster installation plans, the management resource 140 or other suitable entity initiates installation of a selected one or more cluster installation plans of the multiple cluster installation plans in the network environment.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
producing multiple base station cluster installation plans, each of the multiple base station cluster installation plans indicating a corresponding set of wireless base stations to provide wireless services in a network environment;
determining a respective wireless service performance associated with each of the multiple base station cluster installation plans; and
based on the determined respective wireless service performance associated with each of the multiple base station cluster installation plans, initiating installation of base stations associated with a selected base station cluster installation plan of the multiple base station cluster installation plans.

2. The method as in claim 1, wherein the multiple base station cluster installation plans include a first group of base station cluster installation plans, a second group of base station cluster installation plans, and a third group of base station cluster installation plans.

3. The method as in claim 2, wherein the first group of base station cluster installation plans is produced based on first wireless service attributes of the network environment;
wherein the second group of base station cluster installation plans is produced based on second attributes of the network environment; and
wherein the third group of base station cluster installation plans is produced based on third attributes of the network environment.

4. The method as in claim 1, wherein each of the multiple base station cluster installation plans specifies locations of installing the corresponding set of wireless base stations in the network environment.

5. The method as in claim 4 further comprising:
receiving selection criteria indicating at least one selected attribute of interest associated with the multiple base station cluster installation plans; and
choosing the selected base station cluster installation plan amongst the multiple base station cluster installation plans based on the at least one selected attribute of interest.

6. The method as in claim 1, wherein producing the multiple base station cluster installation plans includes:
receiving attributes associated with different locations in the network environment, the received attributes including:
i) wireless service demand information indicating a projected level of demand for wireless services at each respective location within the network environment,
ii) wireless signal conveyance information indicating an ability to communicate wireless signals at each respective location within the network environment, and
iii) wireless signal interference information indicating a projected level of wireless interference at each respective location within the network environment.

7. The method as in claim 6, wherein the multiple base station cluster installation plans include a first base station cluster installation plan, a second base station cluster installation plan, and a third base station cluster installation plan; and
wherein each of the multiple base station cluster installation plans is generated based on a different set of received wireless network parameters associated with different locations in the network environment.

8. The method as in claim 7 further comprising:
producing the first base station cluster installation plan based on a combination of the wireless service demand information, the wireless signal strength information, and the wireless signal interference information;
producing the second base station cluster installation plan based on a combination of the wireless service demand information and the wireless signal strength information; and
producing the third base station cluster installation plan based on a combination of the wireless demand information and the wireless signal interference information.

9. The method as in claim 8 further comprising:
receiving cluster selection criteria indicating a specified attribute of interest; and
choosing the selected base station cluster installation plan amongst the multiple base station cluster installation plans based on the specified attribute interest.

10. The method as in claim 1, wherein each of the multiple base station cluster installation plans is iteratively generated based on respective cluster build criteria indicating at least one wireless network installation parameter.

11. A system comprising:
installation management hardware operative to:
produce multiple base station cluster installation plans, each of the multiple base station cluster installation plans indicating a corresponding set of wireless base stations to provide wireless services in a network environment;
determine a respective wireless service performance associated with each of the multiple base station cluster installation plans; and
based on the determined respective wireless service performance associated with each of the multiple base station cluster installation plans, initiate installation of base stations associated with a selected base station cluster installation plan of the multiple base station cluster installation plans.

12. The system as in claim 11, wherein the multiple base station cluster installation plans include a first group of base station cluster installation plans, a second group of base station cluster installation plans, and a third group of base station cluster installation plans.

13. The system as in claim 12, wherein the first group of base station cluster installation plans is produced based on first wireless service attributes of the network environment;
wherein the second group of base station cluster installation plans is produced based on second attributes of the network environment; and
wherein the third group of base station cluster installation plans is produced based on third attributes of the network environment.

14. The system as in claim 11, wherein each of the multiple base station cluster installation plans specifies locations of installing the corresponding set of wireless base stations in the network environment.

15. The system as in claim 14, wherein the installation management hardware is further operative to:
receive selection criteria indicating at least one selected attribute of interest associated with the multiple base station cluster installation plans; and
choose the selected base station cluster installation plan amongst the multiple base station cluster installation plans based on the at least one selected attribute of interest.

16. The system as in claim 11, wherein the installation management hardware is further operative to:
receive attributes associated with different locations in the network environment, the received attributes including:
i) wireless service demand information indicating a projected level of demand for wireless services at each respective location within the network environment,
ii) wireless signal conveyance information indicating an ability to communicate wireless signals at each respective location within the network environment, and
iii) wireless signal interference information indicating a projected level of wireless interference at each respective location within the network environment.

17. The system as in claim 16, wherein the multiple base station cluster installation plans include a first base station cluster installation plan, a second base station cluster installation plan, and a third base station cluster installation plan; and
wherein each of the multiple base station cluster installation plans is generated based on a different set of received wireless network parameters associated with different locations in the network environment.

18. The system as in claim 17, wherein the installation management hardware is further operative to:
produce the first base station cluster installation plan based on a combination of the wireless service demand information, the wireless signal strength information, and the wireless signal interference information;
produce the second base station cluster installation plan based on a combination of the wireless service demand information and the wireless signal strength information; and
produce the third base station cluster installation plan based on a combination of the wireless demand information and the wireless signal interference information.

19. The system as in claim 18, wherein the installation management hardware is further operative to:
receive cluster selection criteria indicating a specified attribute of interest; and
choose the selected base station cluster installation plan amongst the multiple base station cluster installation plans based on the specified attribute interest.

20. The system as in claim 11, wherein each of the multiple base station cluster installation plans is iteratively generated based on respective cluster build criteria indicating at least one wireless network installation parameter.

21. Computer-readable storage hardware having instructions stored thereon, the instructions, when carried out by computer processor hardware, cause the computer processor hardware to:
produce multiple base station cluster installation plans, each of the multiple base station cluster installation plans indicating a corresponding set of wireless base stations to provide wireless services in a network environment;
determine a respective wireless service performance associated with each of the multiple base station cluster installation plans; and
based on the determined respective wireless service performance associated with each of the multiple base station cluster installation plans, initiate installation of base stations associated with a selected base station cluster installation plan of the multiple base station cluster installation plans.
